(19) United States
(12) Patent Application Publication
(10) Pub. No.: US 2010/0188386 A1
(43) Pub. Date: Jul. 29, 2010

(54) PLASMA DISPLAY DEVICE AND PLASMA DISPLAY PANEL DRIVE METHOD

(75) Inventors: Takahiko Origuchi, Osaka (JP); Hidehiko Shoji, Osaka (JP); Hideki Nakata, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/669,127

(22) PCT Filed: Nov. 12, 2008
(86) PCT No.: PCT/JP2008/003272

§ 371 Date: Jan. 14, 2010

(30) Foreign Application Priority Data
Nov. 19, 2007 (JP) 2007-299027
Sep. 11, 2008 (JP) 2008-233193

(51) Int. Cl. G09G 3/28; G06F 3/038

(52) U.S. Cl. 345/211; 345/68

(57) ABSTRACT

A stable address discharge is generated to achieve a high quality of image display. For this purpose, a plasma display panel, a scan electrode driving circuit, and a partial light-emitting rate detecting circuit are provided. The scan electrode driving circuit performs an address operation by sequentially applying a scan pulse to scan electrodes in an address period. The partial light-emitting rate detecting circuit divides the display area of the plasma display panel into a plurality of regions, and detects a rate of the number of discharge cells to be lit with respect to the number of discharge cells, as a partial light-emitting rate, in each of the regions. The scan electrode driving circuit performs the address operation earlier on the regions having the higher light-emitting rates detected in the partial light-emitting rate detecting circuit in decreasing order of value.

This application is a U.S. National Phase Application of PCT International Application No. PCT/JP2008/003272.

### TECHNICAL FIELD

The present invention relates to a plasma display device for use in a wall-mounted television or a large monitor, and to a driving method for a plasma display panel.

### BACKGROUND ART

A typical alternating-current surface discharge panel used as a plasma display panel (hereinafter abbreviated as “panel”) has a large number of discharge cells that are formed between a front plate and a rear plate faced to each other. The front plate has the following elements:

a plurality of display electrode pairs, each formed of a scan electrode and a sustain electrode, disposed on a front glass substrate in parallel with each other; and

a dielectric layer and a protective layer formed to cover the display electrode pairs. The rear plate has the following elements:

a plurality of parallel data electrodes formed on a rear glass substrate;

a dielectric layer formed over the data electrodes to cover the electrodes;

a plurality of barrier ribs formed on the dielectric layer in parallel with the data electrodes; and

phosphor layers disposed on the surface of the dielectric layer and on the side faces of the barrier ribs.

The front plate and the rear plate are faced to each other so that the display electrode pairs and the data electrodes three-dimensionally intersect, and are sealed together. A discharge gas containing xenon in a partial pressure ratio of 5%, for example, is filled into the inside discharge space. Discharge cells are formed in portions where the display electrode pairs are faced to the data electrodes. In a panel having this structure, gas discharge generates ultraviolet light in each discharge cell. This ultraviolet light excites the red (R), green (G), and blue (G) phosphors so that the phosphors emit the corresponding colors for color display.

A subfield method is typically used as a method for driving the panel. In the subfield method, one field is divided into a plurality of subfields, and light emission or non-light emission of the respective discharge cells in each subfield provides gradation display. Each subfield has an initializing period, an address period, and a sustain period.

In the initializing period, an initializing waveform is applied to the respective scan electrodes, and an initializing discharge is generated in each of the discharge cells. This initializing discharge forms wall charges necessary for the subsequent address operation in the respective discharge cells and generates priming particles (excitation particles for generating an address discharge) for stably causing the address discharge.

In the address period, a scan pulse is sequentially applied to the scan electrodes (hereinafter this operation also being referred to as “scanning”). An address pulse corresponding to the signals of an image to be displayed is applied selectively to the data electrodes (hereinafter, these operations being also generically referred to as “addressing”). Thus, an address discharge is selectively generated between the scan electrodes and the data electrodes, to selectively form wall charges.

In the sustain period, a sustain pulse is applied alternately to display electrode pairs, each formed of a scan electrode and a sustain electrode, at a predetermined number of times corresponding to a luminance to be displayed. Thereby, a sustain discharge is selectively generated in the discharge cells in which the address discharge has formed wall charges. Thus the discharge cells are caused to emit light. In this manner, an image is displayed in the display area of the panel.

For this subfield method, in the initializing period of one subfield among a plurality of subfields, for example, an all-cell initializing operation for causing discharge in all the discharge cells is performed. In the initializing periods of the other subfields, a selective initializing operation for selectively causing an initializing discharge in the discharge cells having undergone a sustain discharge is performed. This operation can minimize light emission unrelated to gradation display and thus improve the contrast ratio.

With the recent increase in the screen size and luminance of the panel, the power consumption of the panel tends to increase. In a panel of a large screen size and high definition, an increase in the load during driving of the panel tends to destabilize the discharge. In order to cause a stable discharge, the driving voltage to be applied to the electrodes is increased. This is one of the causes of further increasing the power consumption. When the drive load or power consumption is increased and exceeds the rated value of the components constituting a driving circuit, the circuit can malfunction.

For example, the data electrode driving circuit performs an address operation for applying an address pulse voltage to the data electrodes and generating an address discharge in the discharge cells. When the power consumption during addressing exceeds the rated value of the integrated circuits (ICs) constituting the data electrode driving circuit, the ICs can malfunction and cause an addressing failure, e.g. occurrence of no address discharge in the discharge cells in which an address discharge is to be generated, or occurrence of an address discharge in the discharge cells in which no address discharge is to be generated. Thus, in order to inhibit the power consumption during addressing, a method (e.g. Patent Document 1) is disclosed. In this method, the power consumption of the data electrode driving circuit is estimated according to the signals of an image to be displayed, and when the estimated value is equal to or higher than a set value, the gradation is limited.

In the address period, as described above, an address discharge is caused by application of a scan pulse voltage to the scan electrodes and application of an address pulse voltage to the data electrodes. Thus it is difficult to cause stable addressing only with the technique of stabilizing the operation of the data electrode driving circuit disclosed in Patent Document 1. A technique of stabilizing the operation of a circuit for driving the scan electrodes (scan electrode driving circuit) is also important.

Further, the scan pulse voltage is sequentially applied to the respective scan electrodes in the address period. Thus particularly in a panel of higher definition, an increasing number of scan electrodes increases the time required for the address period. For this reason, the loss of the wall charge in the discharge cells undergoing addressing in a later part of the address period is larger than the loss of the wall charge in the discharge cells undergoing addressing in an earlier part of the address period. Thus the address discharge in the former cells tends to be unstable.

### [Patent Document 1] Japanese Patent Unexamined Publication No. 2000-66638

### SUMMARY OF THE INVENTION

A plasma display device of the present invention includes the following elements:
a panel being driven by a subfield method in which a plurality of subfields are set in one field,
the subfield having an initializing period, an address period, and a sustain period,
a luminance weight being set for each subfield, and sustain pulses that correspond to the number of the luminance weight being generated in the sustain period so that gradation display is provided,
the panel having display electrode pairs each of which is formed of a scan electrode and a sustain electrode;
a scan electrode driving circuit for performing an address operation by sequentially applying a scan pulse to the scan electrodes, in the address period; and
a partial light-emitting rate detecting circuit for dividing the display area of the panel into a plurality of regions, and for detecting a rate of the number of discharge cells to be lit with respect to the number of cells, as a partial light-emitting rate for each of the regions and for each of the subfields in each of the regions.
   The scan electrode driving circuit performs the address operation earlier on the regions having the higher light-emitting rates detected in the partial light-emitting rate detecting circuit in decreasing order of value.

In this structure, an address discharge can be generated earlier on the regions having the higher light-emitting rates. Thus, in a panel of a large screen size and high definition, an increase in the scan pulse voltage (amplitude) necessary for generating a stable address discharge can be prevented, and a stable address discharge can be generated. As a result, the image display quality of the panel can be improved.

### BRIEF DESCRIPTION OF THE DRAWINGS

FIG. 1 is an exploded perspective view showing a structure of a panel in accordance with a first exemplary embodiment of the present invention.

FIG. 2 is an electrode array diagram of the panel.

FIG. 3 is a waveform chart of driving voltages applied to the respective electrodes of the panel.

FIG. 4 is a circuit block diagram of a plasma display device in accordance with the first exemplary embodiment.

FIG. 5 is a circuit diagram showing a structure of a scan electrode driving circuit of the plasma display device.

FIG. 6 is a schematic diagram showing an example of a connection between regions for detecting partial light-emitting rates and scan ICs in accordance with the first exemplary embodiment.

FIG. 7 is a schematic diagram showing an example of order of address operations of the scan ICs in accordance with the first exemplary embodiment.

FIG. 8 is a characteristics diagram showing a relation between the order of address operations of the ICs and scan pulse voltages (amplitudes) necessary for generating a stable address discharge in accordance with the first exemplary embodiment.

FIG. 9 is a characteristics diagram showing a relation between partial light-emitting rates and scan pulse voltages (amplitudes) necessary for generating a stable address discharge in accordance with the first exemplary embodiment.

FIG. 10 is a circuit block diagram showing a configuration example of a scan IC switching circuit in accordance with the first exemplary embodiment.

FIG. 11 is a circuit diagram showing a configuration example of SID generating circuits in accordance with the first exemplary embodiment.

FIG. 12 is a timing chart for explaining the operation of the scan IC switching circuit in accordance with the first exemplary embodiment.

FIG. 13 is a circuit diagram showing another configuration example of the scan IC switching circuit in accordance with the first exemplary embodiment.

FIG. 14 is a timing chart for explaining another example of the scan IC switching operation in accordance with the first exemplary embodiment.

FIG. 15 is a diagram schematically showing a light-emitting state in a low subfield when a predetermined image is displayed by address operations in an order based on the partial light-emitting rates.

FIG. 16 is a diagram schematically showing a light-emitting state in a low subfield when an image similar to the display image of FIG. 15 is displayed by sequential address operations from the scan electrode at the top end of the panel toward the scan electrode at the bottom end of the panel.

FIG. 17 is a circuit block diagram of a plasma display device in accordance with a second exemplary embodiment of the present invention.

FIG. 18 is a waveform chart of driving voltages applied to respective electrodes of the panel in accordance with a third exemplary embodiment of the present invention.

FIG. 19 is a schematic diagram showing an example of order of scanning based on partial light-emitting rates when a predetermined image is displayed by two-phase driving in accordance with the third exemplary embodiment.

### REFERENCE MARKS IN THE DRAWINGS

1, 2 Plasma display device
10 Panel
21 Front plate
22 Scan electrode
23 Sustain electrode
24 Display electrode pair
25, 33 Dielectric layer
26 Protective layer
31 Rear plate
32 Data electrode
34 Barrier rib
35 Phosphor layer
41 Image signal processing circuit
42 Data electrode driving circuit
43 Scan electrode driving circuit
44 Sustain electrode driving circuit
45, 46 Timing generating circuit
47 Partial light-emitting rate detecting circuit
48 Light-emitting rate comparing circuit
50 Scan pulse generating circuit
51 Initializing waveform generating circuit
52 Sustain pulse generating circuit
60, 67 Scan IC switching circuit
61 SID generating circuit
62, 65 Flip-flop (FF) circuit
63 Delay circuit
64, 66 AND gate

### DETAILED DESCRIPTION OF PREFERRED EMBODIMENTS

Hereinafter, a plasma display device in accordance with exemplary embodiments of the present invention will be described, with reference to the accompanying drawings.

### First Exemplary Embodiment

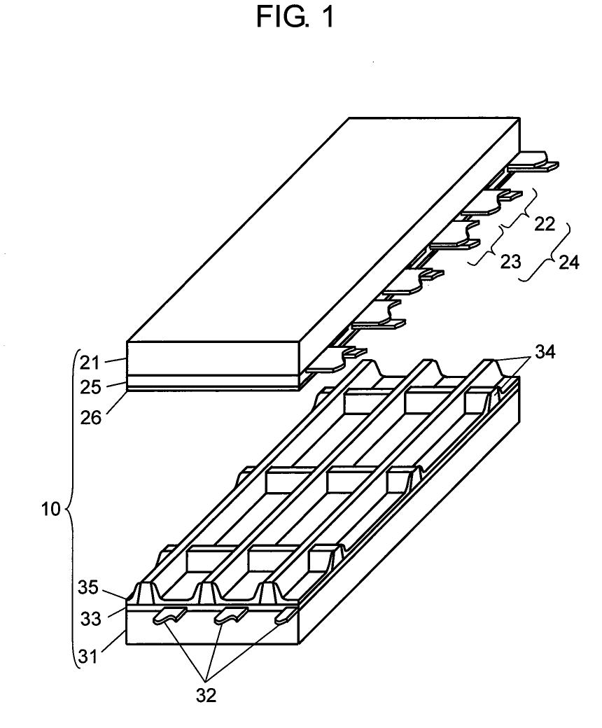

FIG. 1 is an exploded perspective view showing a structure of panel 10 in accordance with the first exemplary embodiment of the present invention. A plurality of display electrode pairs 24, each formed of scan electrode 22 and sustain electrode 23, are disposed on glass front plate 21. Dielectric layer 25 is formed so as to cover scan electrodes 22 and sustain electrodes 23. Protective layer 26 is formed over dielectric layer 25.

In order to lower a breakdown voltage in discharge cells, protective layer 26 is made of a material predominantly composed of MgO. MgO has proven performance as a panel material, and exhibits a large secondary electron emission coefficient and excellent durability when neon (Ne) and xenon (Xe) gas is charged.

A plurality of data electrodes 32 are formed on rear plate 31. Dielectric layer 33 is formed so as to cover data electrodes 32, and mesh barrier ribs 34 are formed on the dielectric layer 33. On the side faces of barrier ribs 34 and on dielectric layer 33, phosphor layers 35 for emitting light of respective colors of red (R), green (G), and blue (B) are formed.

Front plate 21 and rear plate 31 are faced to each other so that display electrode pairs 24 intersect with data electrodes 32 with microscopic discharge spaces sandwiched between the electrodes. The outer peripheries of the plates are sealed with a sealing material, e.g. a glass frit. In the inside discharge space, a mixed gas of neon and xenon is charged as a discharge gas. In this exemplary embodiment, a discharge gas having a xenon partial pressure of approximately 10% is used to improve the emission efficiency. The discharge space is partitioned into a plurality of compartments by barrier ribs 34. Discharge cells are formed in intersecting parts between display electrode pairs 24 and data electrodes 32. The discharge cells discharge and emit light to display an image.

The structure of panel 10 is not limited to the above, and may include barrier ribs formed in a stripe pattern. The mixing ratio of the discharge gas is not limited to the above value, and another mixing ratio can be used.

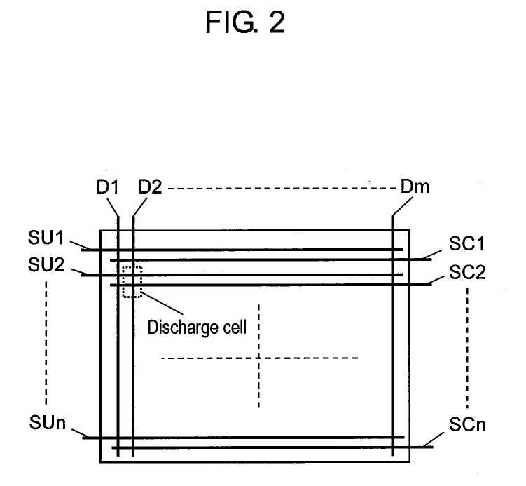

FIG. 2 is an electrode array diagram of panel 10 in accordance with the first exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both long in the row direction, and m data electrode D1 through data electrode Dm (data electrodes 32 in FIG. 1) long in the column direction. A discharge cell is formed in the part where a pair of scan electrode SCi (i=1 through n) and sustain electrode SUi intersects with one data electrode Dj (j=1 through m). Thus, m×n discharge cells are formed in the discharge space. The area in which m×n discharge cells are formed is a display area of panel 10.

Next, driving voltage waveforms for driving panel 10 and the operation thereof are outlined. A plasma display device of this exemplary embodiment provides gradation display by a subfield method: one field is divided into a plurality of subfields along a time axis, a luminance weight is set for each subfield, and emission and non-emission of light in the respective discharge cells are controlled for each subfield (SF).

In this subfield method, one field is formed of 8 subfields (the first SF, and second SF to eighth SF), and the respective subfields have luminance weights of 1, 2, 4, 8, 16, 32, 64, and 128, for example. In the initializing period of one subfield among the plurality of subfields, an all-cell initializing operation for generating an initializing discharge in all the discharge cells is performed (hereinafter, a subfield for an all-cell initializing operation being referred to as “all-cell initializing subfield”). In the initializing periods of the other subfields, a selective initializing operation for generating an initializing discharge selectively in the discharge cells having undergone a sustain discharge is performed (hereinafter, a subfield for a selective initializing operation being referred to as “selective initializing subfield”). Thus light emission unrelated to gradation display can be minimized and the contrast ratio can be improved.

In this exemplary embodiment, in the initializing period of the 1st SF, an all-cell initializing operation is performed. In the initializing periods of the 2nd SF through the 8th SF, a selective initializing operation is performed. With these operations, light emission unrelated to image display is only the light emission caused by the discharge in the all-cell initializing operation. Luminance of black level, i.e. luminance of an area displaying a black picture in which no sustain discharge is caused, is determined only by weak light emission in the all-cell initializing operation. Thus an image having a high contrast can be displayed.

In the sustain period of each subfield, sustain pulses equal in number to the luminance weight of the subfield multiplied by a predetermined proportionality factor are applied to respective display electrode pairs 24. The proportionality factor at this time is a luminance magnification.

However, in this exemplary embodiment, the number of subfields, and the luminance weight of each subfield are not limited to the above values. The subfield structure may be switched according to an image signal, or the like.

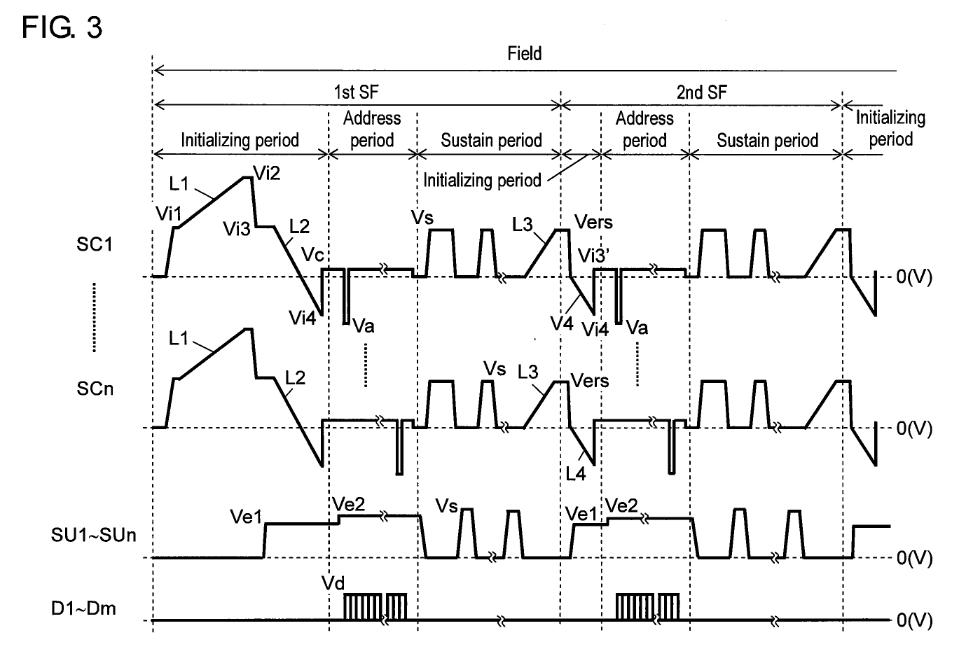

FIG. 3 is a waveform chart of driving voltages applied to the respective electrodes of panel 10 in accordance with the first exemplary embodiment. FIG. 3 shows driving waveforms of scan electrode SC1 scanned first in the address period, scan electrode SCn scanned last in the address period, sustain electrode SU1 through sustain electrode SUn, and data electrode D1 through data electrode Dm.

FIG. 3 shows driving voltage waveforms in two subfields: the first subfield (1st SF), i.e. an all-cell initializing subfield; and the second subfield (2nd SF), i.e. a selective initializing subfield. The driving voltage waveforms in the other subfields are substantially the same as the driving voltage waveforms in the 2nd SF, except that the numbers of sustain pulses generated in the sustain periods are different. Scan electrode SCi, sustain electrode SUi, and data electrode Dk as described below show the electrodes selected from the respective electrodes, according to image data (data showing emission and non-emission of light per subfield).

First, a description is provided of the 1st SF, an all-cell initializing subfield.

In the first half of the initializing period of the 1st SF, 0(V) is applied to each of data electrode D1 through data electrode Dm and sustain electrode SU1 through sustain electrode SUn, and increasing ramp voltage (hereinafter, referred to as “up-ramp voltage”) L1 is applied to scan electrode SC1 through scan electrode SCn. Here, the up-ramp voltage gently (e.g. at a gradient of approximately 1.3 V/μsec) increases from voltage Vi1, which is a breakdown voltage or lower, toward voltage Vi2, which exceeds the breakdown voltage, with respect to sustain electrode SU1 through sustain electrode SUn.

While up-ramp voltage L1 is increasing, a weak initializing discharge continuously occurs between scan electrode SC1 through scan electrode SCn and sustain electrode SU1 through sustain electrode SUn, and between scan electrode SC1 through scan electrode SCn and data electrode D1 through data electrode Dm. Then, negative wall voltage accumulates on scan electrode SC1 through scan electrode SCn. Positive wall voltage accumulates on data electrode D1 through data electrode Dm and sustain electrode SU1 through sustain electrode SUn. Here, the wall voltage on the electrodes means the voltage generated by wall charges that are accumulated on the dielectric layers covering the electrodes, the protective layer, the phosphor layers, or the like.

In the second half of the initializing period, positive voltage Ve1 is applied to sustain electrode SU1 through sustain electrode SUn. A voltage of 0(V) is applied to data electrode D1 through data electrode Dm. Ramp voltage (hereinafter referred to as “down-ramp voltage”) L2 is applied to scan electrode SC1 through scan electrode SCn. Here, the down-ramp voltage gently decreases from voltage V13, which is the breakdown voltage or lower, toward voltage V14, which exceeds the breakdown voltage, with respect to sustain electrode SU1 through sustain electrode SUn.

During this application, a weak initializing discharge occurs between scan electrode SC1 through scan electrode SCn and sustain electrode SU1 through sustain electrode SUn, and between scan electrode SC1 through scan electrode SCn and data electrode D1 through data electrode Dm. This weak discharge reduces the negative wall voltage on scan electrode SC1 through scan electrode SCn, and the positive wall voltage on sustain electrode SU1 through sustain electrode SUn, and adjusts the positive wall voltage on data electrode D1 through data electrode Dm to a value appropriate for the address operation. In this manner, the all-cell initializing operation for causing the initializing discharge in all the discharge cells is completed.

As shown in the initializing period of the 2nd SF in FIG. 3, driving voltage waveforms in which the first half of the initializing period is omitted may be applied to the respective electrodes. That is, voltage Ve1 is applied to sustain electrode SU1 through sustain electrode SUn, and 0 (V) is applied to data electrode D1 through data electrode Dm. Further, down-ramp voltage L4 gently decreasing from a voltage of the breakdown voltage or lower (e.g. a base voltage) toward voltage V14 is applied to scan electrode SC1 through scan electrode SCn. This application causes a weak initializing discharge in the discharge cells having undergone a sustain discharge in the sustain period of the adjacently preceding subfield (the 1st SF in FIG. 3), and reduces the wall voltage on scan electrode SCi and sustain electrode SW. The excessive part of the wall voltage on data electrode Dk (k=1 through m) is discharged, and the wall voltage is adjusted to a value appropriate for the address operation. On the other hand, in the discharge cells having undergone no sustain discharge in the adjacently preceding subfield, no discharge occurs, and the wall charge at the completion of the initializing period of the adjacently preceding subfield is maintained. In this manner, the initializing operation in which the first half is omitted is a selective initializing operation for causing initializing discharge in the discharge cells having undergone a sustain operation in the sustain period of the adjacently preceding subfield.

In the subsequent address period, scan pulse voltage Va is sequentially applied to scan electrode SC1 through scan electrode SCn. Positive address pulse voltage Vd is applied to data electrode Dk (k=1 through m) corresponding to a discharge cell to be lit among data electrode D1 through data electrode Dm. Thus an address discharge is generated selectively in the corresponding discharge cells. At this time, in this exemplary embodiment, according to the detection result in the partial light-emitting rate detecting circuit to be described later, the order of scan electrodes 22 applied with scan pulse voltage Va, or the order of address operations of the ICs for driving scan electrodes 22 are changed. The details will be described later. Herein, a description is provided of a case where scan pulse voltage Va is sequentially applied from scan electrode SC1.

In the address period, first, voltage Ve2 is applied to sustain electrode SU1 through sustain electrode SUn, and voltage Vc is applied to scan electrode SC1 through scan electrode SCn.

Next, negative scan pulse voltage Va is applied to scan electrode SC1 in the first row, and positive address pulse voltage Vd is applied to data electrode Dk (k=1 through m) of the discharge cell to be lit in the first row among data electrode D1 through data electrode Dm. At this time, the voltage difference in the intersecting part between data electrode Dk and scan electrode SC1 is obtained by adding the difference in an externally applied voltage (voltage Vd−voltage Va) to the difference between the wall voltage on data electrode Dk and the wall voltage on scan electrode SC1, and thus exceeds the breakdown voltage. Then, a discharge occurs between data electrodes Dk and scan electrode SC1. Because voltage Ve2 is applied to sustain electrode SU1 through sustain electrode SUn, the voltage difference between sustain electrode SU1 and scan electrode SC1 is obtained by adding the difference in an externally applied voltage (voltage Ve2−voltage Va) to the difference between the wall voltage on sustain electrode SU1 and the wall voltage on scan electrode SC1. At this time, setting voltage Ve2 to a value slightly lower than the breakdown voltage can make a state in which a discharge is likely to occur but not actually occurs between sustain electrode SU1 and scan electrode SC1. With this setting, the discharge generated between data electrode Dk and scan electrode SC1 can trigger the discharge between the areas of sustain electrode SU1 and scan electrode SC1 intersecting with data electrode Dk. Thus, an address discharge occurs in the discharge cells to be lit. Positive wall voltage accumulates on scan electrode SC1 and negative wall voltage accumulates on sustain electrode SU1. Negative wall voltage also accumulates on data electrode Dk.

In this manner, the address operation is performed to cause the address discharge in the discharge cells to be lit in the first row and to accumulate wall voltages on the respective electrodes. On the other hand, the voltage in the intersecting parts between data electrode D1 through data electrode Dm applied with no address pulse voltage Vd and scan electrode SC1 does not exceed the breakdown voltage, and thus no address discharge occurs. The above address operation is performed on the discharge cells up to the n-th row and the address period is completed.

In the sequential sustain period, sustain pulses equal in number to the luminance weight multiplied by the luminance magnification are applied alternately to display electrode pairs 24. Thereby, a sustain discharge is caused in the discharge cells having undergone the address discharge, for light emission.

In this sustain period, first, positive sustain pulse voltage Vs is applied to scan electrode SC1 through scan electrode SCn, and the ground potential as a base potential, i.e. 0(V), is applied to sustain electrode SU1 through sustain electrode SUn. Then, in the discharge cells having undergone the address discharge, the voltage difference between scan electrode SCi and sustain electrode SUi is obtained by adding sustain pulse voltage Vs to the difference between the wall voltage on scan electrode SCi and the wall voltage on sustain electrode SUi, and thus exceeds the breakdown voltage.

Then, a sustain discharge occurs between scan electrode SCi and sustain electrode SW, and ultraviolet light generated at this time causes phosphor layers 35 to emit light. Thus negative wall voltage accumulates on scan electrode SCi, and positive wall voltage accumulates on sustain electrodes SUi. Positive wall voltage also accumulates on data electrode Dk. In the discharge cells having undergone no address discharge in the address period, no sustain discharge occurs and the wall voltage at the completion of the initializing period is maintained.

Subsequently, 0 (V) as the base potential is applied to scan electrode SC1 through scan electrode SCn, and sustain pulse voltage Vs is applied to sustain electrode SU1 to sustain electrode SUn. In the discharge cell having undergone the sustain discharge, the voltage difference between sustain electrode SUi and scan electrode SCi exceeds the breakdown voltage. Thereby, a sustain discharge occurs between sustain electrode SUi and scan electrode SCi again. Thus negative wall voltage accumulates on sustain electrode SUi, and positive wall voltage accumulates on scan electrode SCi. Similarly, sustain pulses equal in number to the luminance weight multiplied by the luminance magnification are applied alternately to scan electrode SC1 through scan electrode SCn and sustain electrode SU1 through sustain electrode SUn to cause a potential difference between the electrodes of display electrode pairs 24. Thus the sustain discharge is continued in the discharge cells having undergone the address discharge in the address period.

After the sustain pulses have been generated in the sustain period, ramp voltage (hereinafter, referred to as “erasing ramp voltage”) L3 gently increasing from 0 (V) toward voltage Vers is applied to scan electrode SC1 through scan electrode SCn. Thus, in the discharge cells having undergone the sustain discharge, a weak discharge is continuously generated, and a part or the whole of the wall voltages on scan electrode SCi and sustain electrode SUi is erased, while the positive wall voltage is left on data electrode Dk.

Specifically, after sustain electrode SU1 through sustain electrode SUn are returned to 0 (V), erasing ramp voltage L3 that increases from 0 (V) as the base potential toward voltage Vers exceeding the breakdown voltage is generated with a gradient (of approximately 10 V/μsec, for example), which is steeper than the gradient of up-ramp voltage L1. The erasing ramp voltage L3 is applied to scan electrode SC1 through scan electrode SCn. Then, a weak discharge occurs between sustain electrode SUi and scan electrode SCi in the discharge cell having undergone the sustain discharge. This weak discharge is continuously generated while the voltage applied to scan electrode SC1 through scan electrode SCn is increasing. After the increasing voltage has reached voltage Vers as a predetermined voltage, the voltage applied to scan electrode SC1 through scan electrode SCn is dropped to 0 (V) as the base potential.

At this time, the charged particles generated by this weak discharge accumulate on sustain electrode SUi and scan electrode SCi as wall charges so as to reduce the voltage difference between sustain electrode SUi and scan electrode SCi. Thus, while the positive wall charge is left on data electrode Dk, the wall voltage between scan electrode SC1 through scan electrode SCn and sustain electrode SU1 through sustain electrode SUn is decreased to the difference between the voltage applied to scan electrode SCi and the breakdown voltage, i.e. a degree of (voltage Vers−the breakdown voltage). Hereinafter, the final discharge in each sustain period generated by erasing ramp voltage L3 is referred to as “erasing discharge”.

The respective operations in the subsequent 2nd SF and thereafter are substantially similar to the above operation, except for the number of sustain pulses in the sustain periods. Thus the descriptions are omitted. The above descriptions have outlined driving voltages applied to the respective electrodes of panel 10 in this exemplary embodiment.

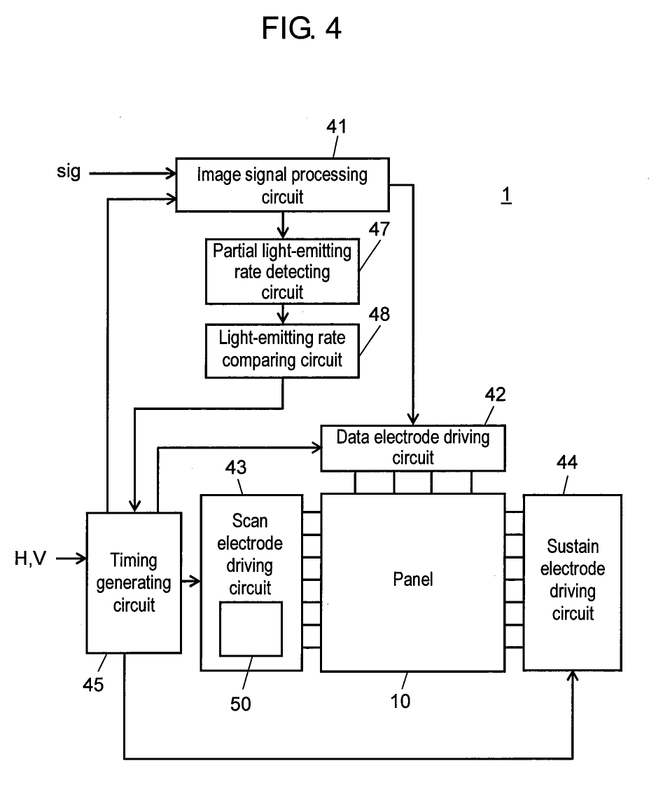

Next, a structure of plasma display device 1 in accordance with this exemplary embodiment is described. FIG. 4 is a circuit block diagram of plasma display device 1 in accordance with the first exemplary embodiment of the present invention. Plasma display device 1 has the following elements:

panel 10;

image signal processing circuit 41;

data electrode driving circuit 42;

scan electrode driving circuit 43;

sustain electrode driving circuit 44;

timing generating circuit 45;

partial light-emitting rate detecting circuit 47;

light-emitting rate comparing circuit 48; and

power supply circuits (not shown) for providing power supply necessary for the respective circuit blocks.

Image signal processing circuit 41 converts input image signal sig to image data showing emission and non-emission of light for each subfield.

Partial light-emitting rate detecting circuit 47 divides the display area of panel 10 into a plurality of regions, and detects a rate of the number of discharge cells to be lit with respect to the number of discharge cells in each region, for each region and for each subfield, according to the image data per subfield. (Hereafter, the rate of the number of discharge cells to be lit that are detected in each region is referred to as “partial light-emitting rate”.) Partial light-emitting rate detecting circuit 47 may detect a light-emitting rate in one display electrode pair 24, for example, as the partial light-emitting rate. However, herein, the partial light-emitting rate is detected in a region that is formed of a plurality of scan electrodes 22 connected to one IC for driving scan electrodes 22 (hereinafter referred to as “scan ICs”).

Light-emitting rate comparing circuit 48 compares the values of the partial light-emitting rates of the respective regions detected by partial light-emitting rate detecting circuit 47, and determines the position of each region in decreasing order of value. The light-emitting rate comparing circuit outputs the signal showing the results to timing generating circuit 45 for each subfield.

Timing generating circuit 45 generates various timing signals for controlling the operation of the respective circuit blocks according to horizontal synchronizing signal H, vertical synchronizing signal V, and the output from light-emitting rate comparing circuit 48, and supplies the timing signals to the respective circuit blocks.

Scan electrode driving circuit 43 has the following elements: an initializing waveform generating circuit (not shown) for generating initializing waveform voltages to be applied to scan electrode SC1 through scan electrode SCn in the initializing periods;

a sustain pulse generating circuit (not shown) for generating sustain pulses to be applied to scan electrode SC1 through scan electrode SCn in the sustain periods; and

scan pulse generating circuit 50 having a plurality of scan ICs, for generating scan pulse voltage Va to be applied to scan electrode SC1 through scan electrode SCn in the address periods.

The scan electrode driving circuit 43 drives each of scan electrode SC1 through scan electrode SCn, according to the timing signals. At this time, in this embodiment, scan ICs are sequentially switched for the address operation so that the address operation is performed earlier on the regions having the higher partial light-emitting rates in decreasing order of value. Thus, a stable address discharge is achieved. A detailed description will be given later.

Data electrode driving circuit 42 converts image data per subfield into signals corresponding to data electrode D1 through data electrode Dm, and drives data electrode D1 through data electrode Dm according to the timing signals. As described above, in this embodiment, the order of addressing can be different in each subfield. Thus timing generating circuit 45 generates timing signals so that address pulse voltage Vd is generated in data driving circuit 42 according to the order in which scan ICs perform address operations. Thus an address operation appropriate for a display image can be performed.

Sustain electrode driving circuit 44 has a sustain pulse generating circuit, and a circuit (not shown) for generating voltage Ve1 and voltage Vet, and drives sustain electrodes SU1 through SUn in response to the timing signals.

Next, scan electrode driving circuit 43 is detailed and the operation thereof is described.

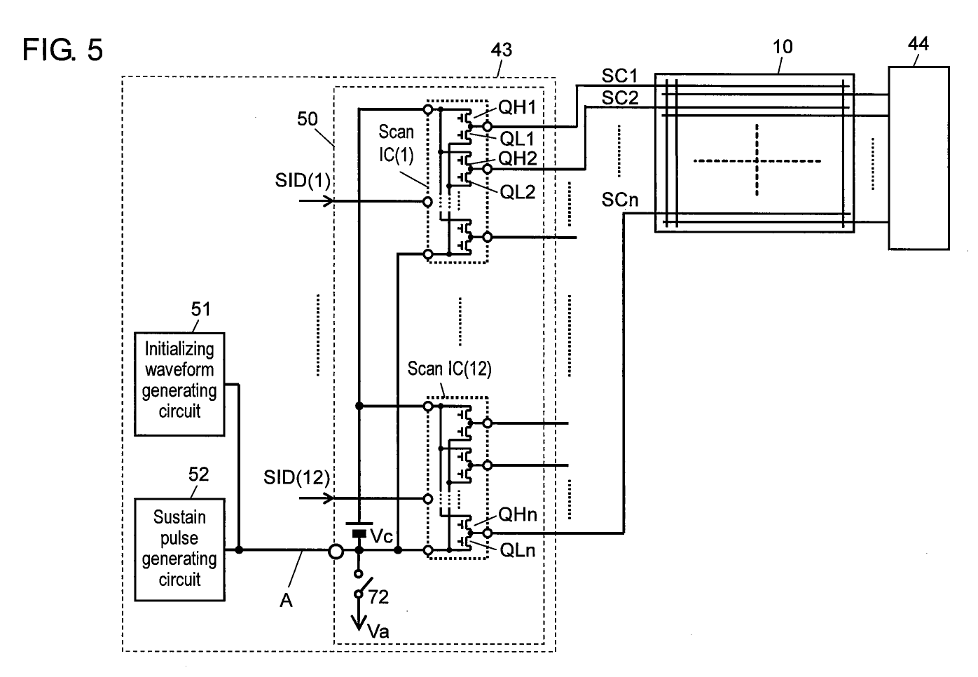

FIG. 5 is a circuit diagram showing a structure of scan electrode driving circuit 43 of plasma display device 1 in accordance with the first exemplary embodiment of the present invention. Scan electrode driving circuit 43 has scan pulse generating circuit 50, initializing waveform generating circuit 51, and sustain pulse generating circuit 52 on the side of scan electrodes 22. The respective outputs of scan pulse generating circuit 50 are connected to scan electrode SC1 through scan electrode SCn.

Initializing waveform generating circuit 51 increases and decreases reference potential A of scan pulse generating circuit 50 in a ramp form in the initializing periods, and thereby generates the initializing waveform voltages shown in FIG. 3.

Sustain pulse generating circuit 52 changes reference potential A of scan pulse generating circuit 50 to voltage Vs or the base potential, and thereby generates the sustain pulses shown in FIG. 3.

Scan pulse generating circuit 50 has the following elements:

switch 72 for connecting reference potential A to negative voltage Va in the address periods;

power supply VC for supplying voltage Vc; and

switching element QH1 through switching element QHn and switching element QL1 through switching element QLn for applying scan pulse voltage Va to n scan electrode SC1 through scan electrode SCn.

Switching element QH1 through switching element QHn and switching element QL1 through switching element QLn are grouped in a plurality of outputs and formed into ICs. These ICs are scan ICs. Switching element QHi is switched off and switching element QLi is switched on. Thereby, negative scan pulse voltage Va is applied to scan electrode SCi via switching element QLi. In the following descriptions, the operation of bringing a switching element into conduction is denoted as “ON”, and the operation of bringing a switching element out of conduction is denoted as “OFF”. A signal for setting the switching element at ON is denoted as “Hi”, and a signal for setting the switching element at OFF is denoted as “Lo”.

While initializing waveform generating circuit 51 or sustain pulse generating circuit 52 is operated, switching element QH1 through switching element QHn are set at OFF, and switching element QL1 through switching element QLn are set at ON. Thereby, the initializing waveform voltage or sustain pulse voltage Vs is applied to scan electrode SC1 through scan electrode SCn via switching element QL1 through switching element QLn.

The following descriptions are provided of a case where switching elements for 90 outputs are integrated into one monolithic IC and panel 10 has 1,080 scan electrodes 22. Twelve scan ICs form scan pulse generating circuit 50, and drive 1,080 electrodes, i.e. scan electrode SC1 through scan electrode SCn. In this manner, integration of a large number of switching element QH1 through switching element QHn and switching element QL1 through switching element QLn into ICs can reduce the number of components and thus the mounting area. However, the shown numerical values are merely examples, and the present invention is not limited to these values.

In this embodiment, SID (1) through SID (12) output from timing generating circuit 45 are input to scan IC (1) through scan IC (12), respectively, in the address periods. These SID (1) through SID (12) are operation start signals for causing the scan ICs to start address operations. The order of address operations of scan IC (1) through scan IC (12) is changed according to SID (1) through SID (12).

For example, when scan IC (2) connected to scan electrode SC91 through scan electrode SC180 is caused to perform address operation after scan IC (3) connected to scan electrode SC181 through scan electrode SC270 is caused to perform address operation, the following operation is performed.

Timing generating circuit 45 changes SID (3) from Lo (e.g. 0(V)) to Hi (e.g. 5(V)) and instructs scan IC (3) to start address operation. Scan IC (3) detects a change in the voltage of SID (3), and starts address operation in response to the detection. First, switching element QH181 is set at OFF, and switching element QL181 is set at ON. Thereby, via switching element QL181, scan pulse voltage Va is applied to scan electrode SC181. After the completion of addressing in scan electrode SC181, switching element QH181 is set at ON, and switching element QL181 is set at OFF. Sequentially, switching element QH182 is set at OFF, and switching element QL182 is set at ON. Thereby, via switching element QL182, scan pulse voltage Va is applied to scan electrode SC182. The series of address operations are sequentially performed so that scan pulse voltage Va is sequentially applied to scan electrode SC181 through scan electrode SC270. Thus, scan IC (3) completes address operation.

After the completion of the address operation of scan IC(3), timing generating circuit 45 changes SID (2) from Lo (e.g. 0(V)) to Hi (e.g. 5 (V)) and instructs scan IC (2) to start address operation. Scan IC (2) detects a change in the voltage of SID (2), and performs address operation similar to the above, in response to the detection. Thus, the scan IC sequentially applies scan pulse voltage Va to scan electrode SC91 through scan electrode SC180.

In this embodiment, the order of address operations of scan ICs can be controlled, using the SIDs, i.e. operation start signals, in this manner.

In this embodiment, as described above, the order of the address operations of the scan ICs is determined, according to the partial light-emitting rates detected in partial light-emitting rate detecting circuit 47. Thus, a scan IC that drives a region having a higher partial light-emitting rate is caused to perform address operation earlier. An example of these operations is described, with reference to the accompanying drawings.

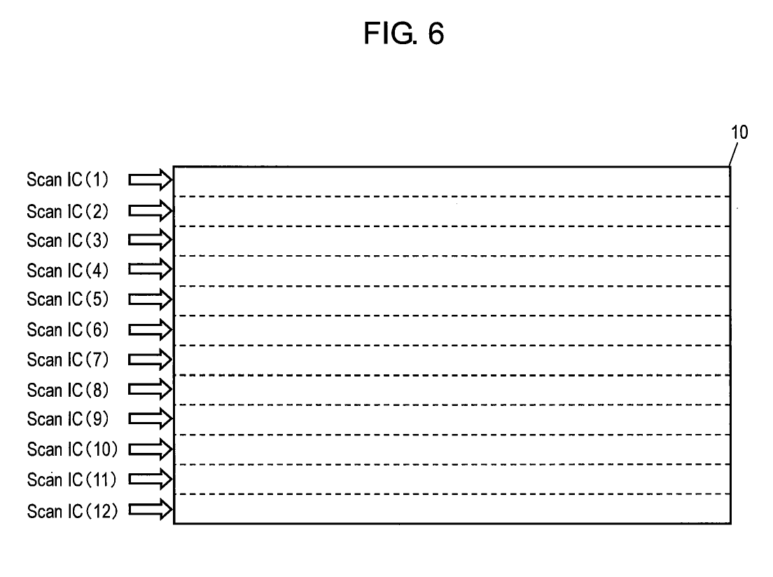

FIG. 6 is a schematic diagram showing an example of a connection between regions for detecting partial light-emitting rates and scan ICs in accordance with the first exemplary embodiment of the present invention. FIG. 6 schematically shows how panel 10 is connected to scan ICs. Each of the areas surrounded by the broken lines in panel 10 shows the region in which partial light-emitting rates are detected. Display electrode pairs 24 are arranged so as to extend in the horizontal direction in the drawing in a similar manner to FIG. 2.

As described above, partial light-emitting rate detecting circuit 47 sets the area that is formed of a plurality of scan electrodes 22 connected to one scan IC as one region, and detects partial light-emitting rates. For example, the number of scan electrodes 22 connected to one scan IC is 90, and scan electrode driving circuit 43 has 12 scan ICs (scan IC (1) through scan IC (12)). In this case, as shown in FIG. 6, partial light-emitting rate detecting circuit 47 sets 90 scan electrodes 22 connected to each of scan IC (1) through scan IC (12) as one region, divides the display area of panel 10 into 12 regions, and detects partial light-emitting rates for each of the regions. Light-emitting rate comparing circuit 48 compares the values of the partial light-emitting rates detected in partial light-emitting rate detecting circuit 47, and sets the order of the regions in decreasing order of value. Timing generating circuit 45 generates timing signals based on the order. In response to the timing signals, scan electrode driving circuit 43 causes the scan IC that is connected to the region having a higher partial light-emitting rate to perform address operation earlier.

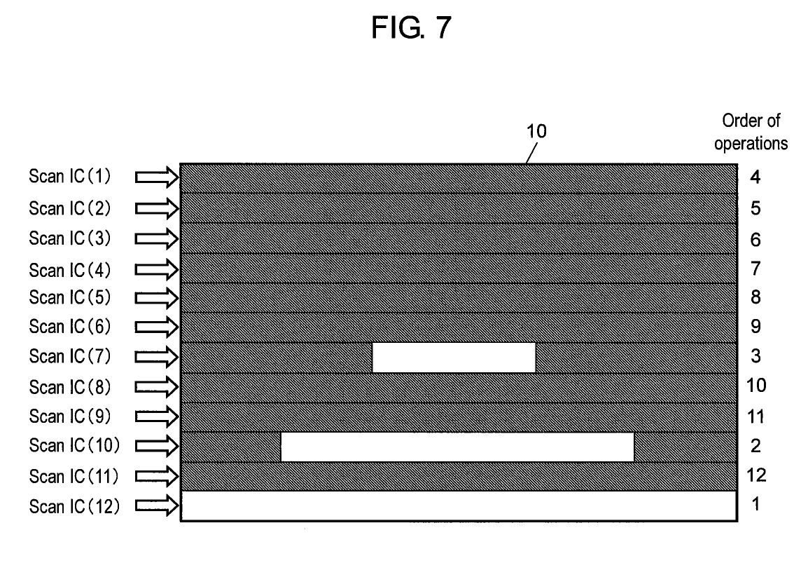

FIG. 7 is a schematic diagram showing an example of order of address operations of scan IC (1) through scan IC (12) in accordance with the first exemplary embodiment of the present invention. In FIG. 7, the regions in which partial light-emitting rates are detected are the same as the regions shown in FIG. 6. The diagonally shaded regions show the distribution of unlit cells in which no sustain discharge is generated. The outline regions that are not diagonally shaded show the distribution of lit cells in which a discharge is generated.

For example, when lit cells are distributed as shown in FIG. 7 in a subfield, the region having the highest partial light-emitting rate is the region connected to scan IC (12) (hereinafter, a region connected to scan IC (n) being referred to as “region (n)”). The region having the second highest partial light-emitting rate is region (10) connected to scan IC (10). The region having the third highest partial light-emitting rate is region (7) connected to scan IC (7). At this time, in a conventional address operation, the address operation is sequentially switched from scan IC (1) to scan IC (2) and scan IC (3). The address operation of scan IC (12) connected to the region having the highest partial light-emitting rate is started last. However, in this exemplary embodiment, the scan IC having a higher light-emitting rate is caused to perform address operation earlier. Thus, as shown in FIG. 7, firstly, scan IC (12) is caused to perform an address operation. Secondly, scan IC (10) is caused to perform an address operation. Thirdly, scan IC (7) is caused to perform an address operation. In this exemplary embodiment, when the partial light-emitting rates are equal, the scan IC connected to scan electrodes 22 in the upper position is caused to perform the address operation earlier. As a result, the address operation after scan IC (7) is caused in the following order: scan IC (1), scan IC (2), scan IC (3), scan IC (4), scan IC (5), scan IC (6), scan IC (8), scan IC (9), and scan IC (11). The address operations are performed in the regions in the following order: region (12), region (10), region (7), region (1), region (2), region (3), region (4), region (5), region (6), region (8), region (9), and region (11).

As described above, in this exemplary embodiment, the scan IC connected to the region having a higher partial light-emitting rate is caused to perform address operation earlier. Thereby, the address operation is performed earlier on the regions having the higher partial light-emitting rates, and thus a stable address discharge is achieved. This is due to the following reasons.

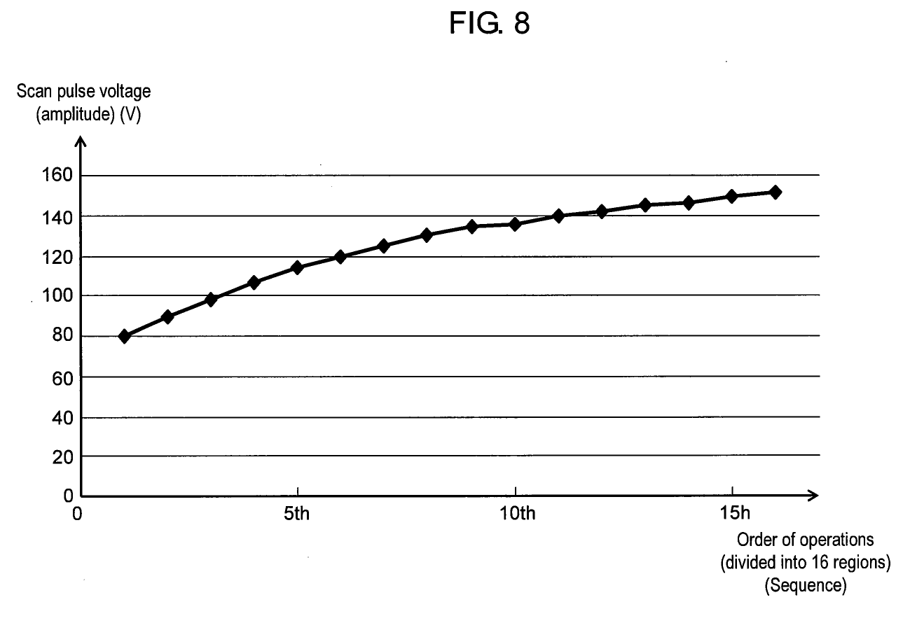

FIG. 8 is a characteristics diagram showing a relation between the order of address operations of the scan ICs and scan pulse voltages (amplitudes) necessary for generating a stable address discharge in accordance with the first exemplary embodiment of the present invention. In FIG. 8, the ordinate axis shows scan pulse voltages (amplitudes) necessary for generating a stable address discharge, and the abscissa axis shows the order of the address operations of the scan ICs. In this experiment, one screen is divided into 16 regions, and scan pulse generating circuit 50 has 16 scan ICs so as to drive scan electrode SC1 through scan electrode SCn. Further, it is measured how the scan pulse voltage (amplitude) necessary for generating a stable address discharge changes according to the order of the address operations of the scan ICs.

As shown in FIG. 8, according to the order of the address operations of the scan ICs, the scan pulse voltage (amplitude) necessary for generating a stable address discharge changes. Specifically, in a scan IC in a later part of the sequence of the address operations, the scan pulse voltage (amplitude) necessary for generating the stable address discharge is larger. For example, in the scan IC caused to perform the address operation first, the scan pulse voltage (amplitude) necessary for generating the stable address discharge is approximately 80 (V). In the scan IC caused to perform the address operation last (the 16th, herein), the necessary scan pulse voltage (amplitude) is approximately 150 (V), which is larger by approximately 70 (V).

This is considered to result from a gradual decrease in the wall charge formed in the initializing period with a lapse of time. Further, because address pulse voltage Vd is applied to data electrodes 32 during the address period (according to the display image), address pulse voltage Vd is also applied to the discharge cells undergoing no address operation. The wall charge is reduced also by such a voltage change. Thus it is considered that in the discharge cells undergoing the address operation in a later part of the address period, the wall charge is further reduced.

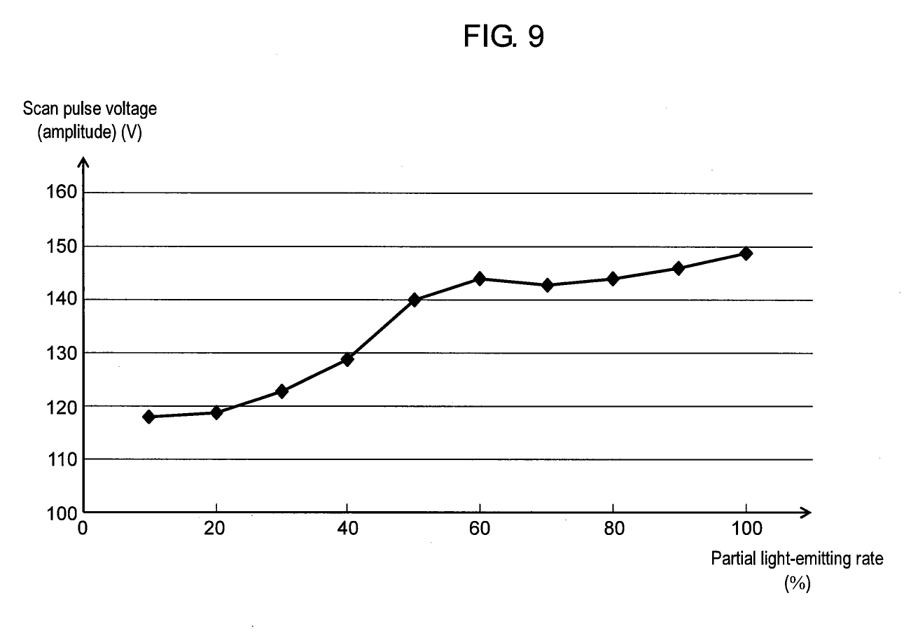

FIG. 9 is a characteristics diagram showing a relation between partial light-emitting rates and scan pulse voltages (amplitudes) necessary for generating a stable address discharge in accordance with the first exemplary embodiment of the present invention. In FIG. 9, the ordinate axis shows scan pulse voltages (amplitudes) necessary for generating a stable address discharge, and the abscissa axis shows the partial light-emitting rates. In this experiment, in a manner similar to the measurement of FIG. 8, one screen is divided into 16 regions. Further, it is measured how the scan pulse voltage (amplitude) necessary for generating a stable address discharge changes while the rate of lit cells is changed in one of the regions.

As shown in FIG. 9, according to the rate of lit cells, the scan pulse voltage (amplitude) necessary for generating a stable address discharge changes. Specifically, at a higher light-emitting rate, the scan pulse voltage (amplitude) necessary for generating a stable address discharge is larger. For example, at a light-emitting rate of 10%, the scan pulse voltage (amplitude) necessary for generating a stable address discharge is approximately 118 (V). At a light-emitting rate of 100%, the necessary scan pulse voltage (amplitude) is approximately 149 (V), which is larger by approximately 31 (V).

This is considered to result from the following reason. When the number of lit cells and thus the light-emitting rate are increased, the discharge current and the voltage drop of the scan pulse voltage (amplitude) are increased. Further, when an increase in the screen size of panel 10 increases the length of scan electrode 22 and thus the drive load, the voltage drop is further increased.

In this manner, the scan pulse voltage (amplitude) necessary for generating a stable address discharge is larger, when a scan IC in a later part of the sequence performs the address operation, i.e. when a lapse of time from the initializing operation to address operation is longer. The scan pulse voltage is also larger at a higher light-emitting rate.

Thus, when a scan IC in a later part of the sequence performs the address operation and the light-emitting rate of the region connected to the scan IC is high, the scan pulse voltage (amplitude) necessary for generating a stable address operation is further increased.

However, in a case where a region has a high partial light-emitting rate but the scan IC connected to the region is caused to perform the address operation earlier, the scan pulse voltage (amplitude) necessary for generating a stable address discharge can be made smaller than the scan pulse voltage when the scan IC connected to the region is caused to perform the address operation later.

Thus, in this exemplary embodiment, a partial light-emitting rate is detected per region, and the scan IC connected to the region having a higher partial light-emitting rate is caused to perform the address operation earlier. With this structure, the address operation can be performed earlier on a region having a higher partial light-emitting rate. Thus the address operation can be performed on a region having a higher partial light-emitting rate so that the lapse of time from the initializing operation to the address operation in the region is shorter than the lapse of time in the address operation on a region having a lower partial light-emitting rate. This operation can prevent an increase in the scan pulse voltage (amplitude) necessary for generating a stable address discharge, and generate a stable address discharge. The experiments conducted by the inventors have verified that the structure of this exemplary embodiment can reduce the scan pulse voltage (amplitude) necessary for generating a stable address discharge, by approximately 20 (V), which depends on the display images.

Next, a description is provided of an example of a circuit for generating SIDs, i.e. operation start signals to scan ICs, (SID(1) through SID(12) herein) shown in FIG. 5, with reference to the drawings.

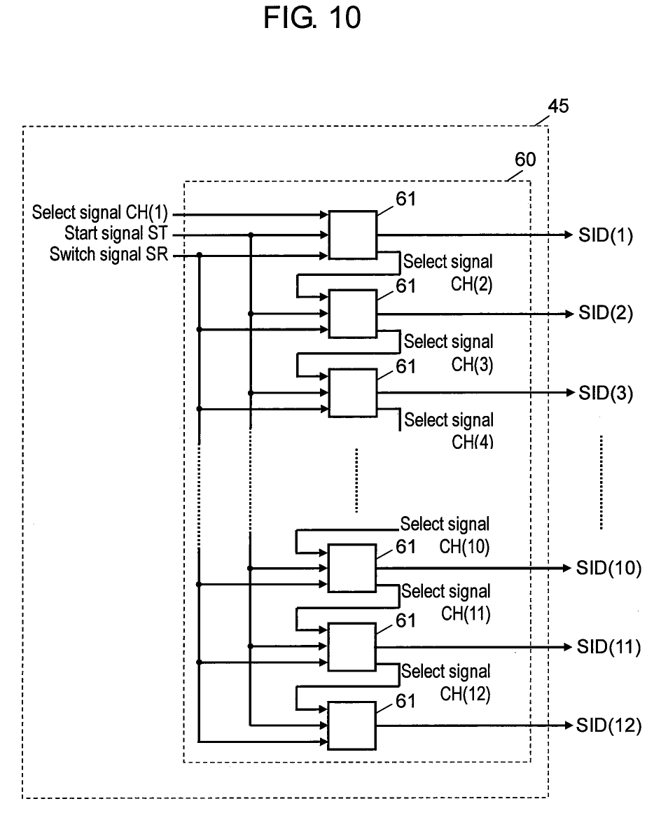

FIG. 10 is a circuit block diagram showing a configuration example of scan IC switching circuit 60 in accordance with the first exemplary embodiment of the present invention. Timing generating circuit 45 has scan IC switching circuit 60 for generating SIDs (SID(1) through SID(12), herein). Though not shown, clock signal CK, i.e. a reference of operation timing of each circuit, is input to each scan IC switching circuit 60.

As shown in FIG. 10, scan IC switching circuit 60 has SID generating circuits 61 equal in number to the SIDs to be generated (12 circuits, herein). Switch signal SR generated according to the comparison results in light-emitting rate comparing circuit 48, select signal CH generated in a scan IC selecting sub-period in each address period, and start signal ST generated at the start of the address operation of the scan IC are input to each SID generating circuit 61. Then, each SID generating circuit 61 outputs an SID based on the respective input signals. Each of the signals is generated in timing generating circuit 45 except that select signal CH delayed by a predetermined time period in each SID generating circuit 61 is used for SID generating circuit 61 at the next stage. For example, select signal CH (1) input to first SID generating circuit 61 is delayed in this SID generating circuit 61 by the predetermined time period to provide select signal CH (2), and this select signal CH (2) is input to SID generating circuit 61 at the next stage. Thus, switch signal SR and start signal ST are input to each SID generating circuit 61 at the same timing, but all the select signals CH are input at different timings.

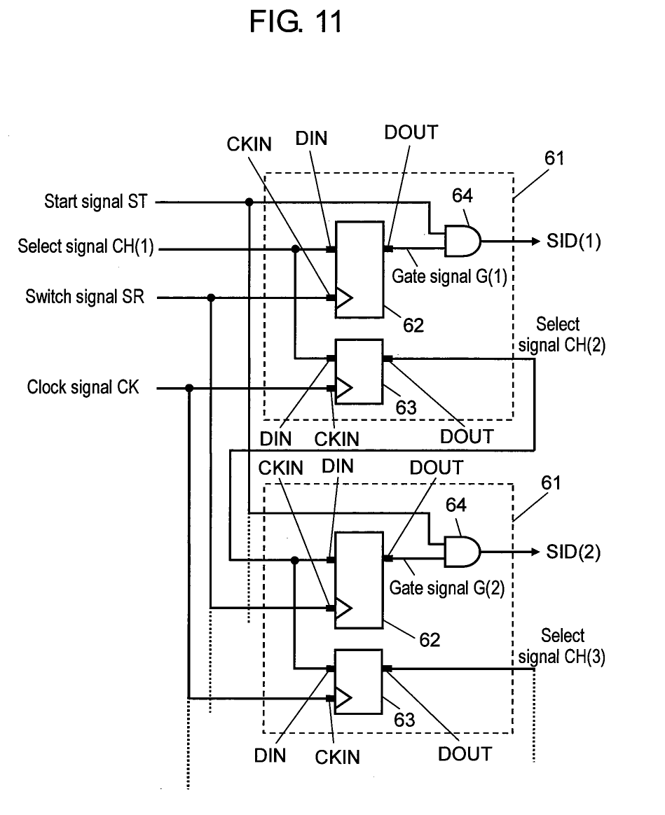

FIG. 11 is a circuit diagram showing a configuration example of SID generating circuits 61 in accordance with the first exemplary embodiment of the present invention. Each SID generating circuit 61 has flip-flop circuit (hereinafter, “FF”) 62, delay circuit 63, and AND gate 64.

FF 62 is configured and operates in a similar manner to a generally known flip-flop circuit. The FF has clock input terminal CKIN, data input terminal DIN, and data output terminal DOUT. The FF holds the state (Lo or Hi) of data input terminal DIN (select signal CH to be input, herein) at the time of the rising edge of the signal (at the time of changing the Lo state to the Hi state) that is input to clock input terminal CKIN (switch signal SR, herein), and outputs the inverted state, as gate signal G, from data output terminal DOUT.

In AND gate 64, gate signal G output from FF 62 is input to one of the input terminals, and start signal ST is input to the other input terminal. The AND gate performs an AND operation on the two signals, and outputs the results. That is, only when gate signal G is in the Hi state and start signal ST is in the Hi state, the Hi state is output. In the other cases, the Lo state is output. The output of AND gate 64 is the SID.

Delay circuit 63 is configured and operates in a similar manner to a generally known delay circuit. The delay circuit has clock input terminal CKIN, data input terminal DIN, and data output terminal DOUT. The delay circuit delays a signal that is input to data input terminal DIN (select signal CH, herein) by a predetermined cycle (one cycle, herein) of clock signal CK that is input to clock input terminal CKIN, and outputs the delayed signal from data output terminal DOUT. This output is used as select signal CH in SID generating circuit 61 at the next stage.

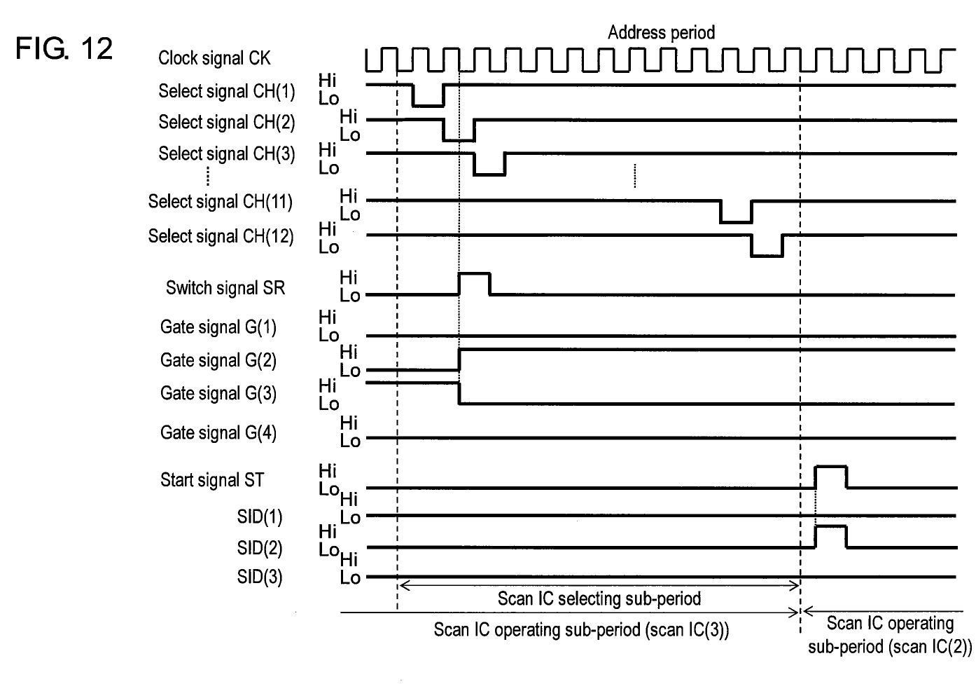

These operations are described with reference to a timing chart. FIG. 12 is a timing chart for explaining the operation of scan IC switching circuit 60 in accordance with the first exemplary embodiment of the present invention. Herein, a description is provided, using the operation of scan IC switching circuit 60 when scan IC (2) is caused to perform address operation next to scan IC (3), as an example. Each of the signals shown herein is generated after the generation timing thereof is determined in timing generating circuit 45, according to the comparison results of light-emitting rate comparing circuit 48.

In this exemplary embodiment, a scan IC to be caused to perform the address operation next is determined in a scan IC selecting sub-period set in the address period. However, the scan IC selecting sub-period for determining the scan IC to be caused to perform the address operation first is set immediately before the address period. In a position immediately before the address operation of a scan IC under address operation is completed, the scan IC selecting sub-period for determining a scan IC to be caused to perform address operation next is set.

In the scan IC selecting sub-period, first, select signal CH (1) is input to SID generating circuit 61 for generating SID (1). As shown in FIG. 12, this select signal CH (1) has a pulse waveform of negative polarity that is in the Hi state normally and in the Lo state only in the period equal to one cycle of clock signal CK. Select signal CH (1) is delayed by one cycle of clock signal CK1 in SID generating circuit 61, to provide select signal CH (2), which is input to SID generating circuit 61 for generating SID (2). Thereafter, select signal CH (3) through select signal CH (12), each delayed by one cycle of clock signal CK1, are input to corresponding SID generating circuits 61.

As shown in FIG. 12, switch signal SR has a pulse waveform of positive polarity that is in the Lo state normally and in the Hi state only in the period equal to one cycle of clock signal CK. The positive pulse is generated at the following timing when select signal CH for selecting the scan IC to be caused to perform the address operation next changes to the Lo state, in select signal CH (1) through select signal CH (12) each delayed by one cycle of clock signal CK1. Thus FF 62 outputs a signal that shows the inverted state of the state of select signal CH at the time of rising edge of switch signal SR input to clock input terminal CKIN, as gate signal G.

For example, when scan IC (2) is selected, a positive pulse is generated as switch signal SR, at the time point when select signal CH (2) changes to the Lo state as shown in FIG. 12. At this time, select signals CH except select signal CH (2) are in the Hi state. Thus only gate signal G (2) is in the Hi state and the other gate signals G are in the Lo state. Herein, gate signal G (3) changes from the Hi state to the Lo state at this timing.

Switch signal SR may be generated so as to change the state thereof in synchronization with the falling edge of clock signal CK. This operation can provide a time lag by a half of the cycle of clock signal CK with respect to changes in the state of select signals CH. Thus the operation in FF 62 can be ensured.

Next, at the timing when the address operation of the scan IC is started, a positive pulse that is in the Hi state in the period equal to one cycle of clock signal CK is generated as start signal ST. Start signal ST is input to each SID generating circuit 61 in common. However, only AND gate 64 having gate signal G in the Hi state can output a positive pulse. Thus a scan IC to be caused to perform an address operation next can be optionally determined. Herein, gate signal G (2) is in the Hi state, and thus a positive pulse is generated as SID (2), and scan IC (2) starts the address operation.

With the above circuit configuration, SIDs can be generated. However, the circuit configuration shown herein is merely an example, and the present invention is not limited to this circuit configuration. Any configuration may be used as long as the configuration is capable of generating SIDs for instructing the scan ICs to start address operations.

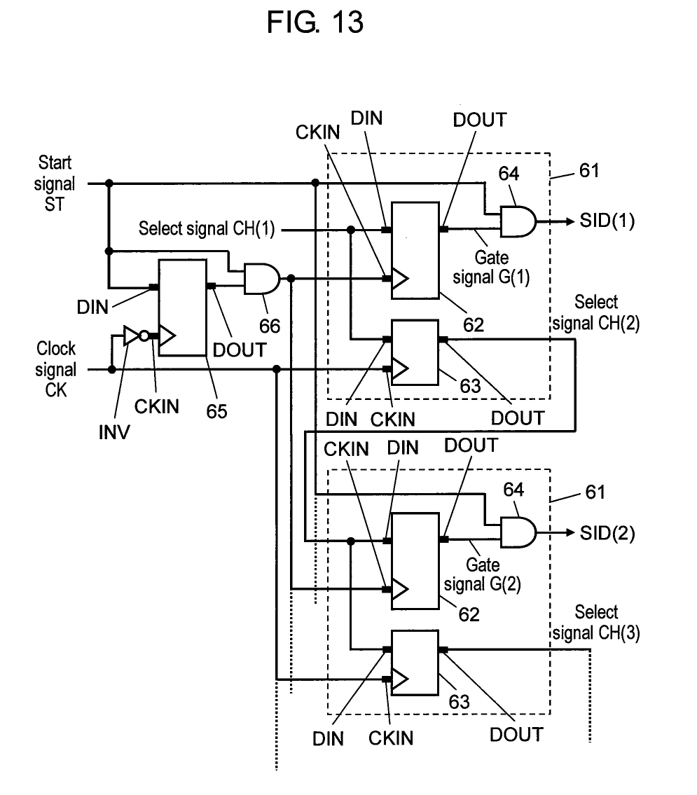

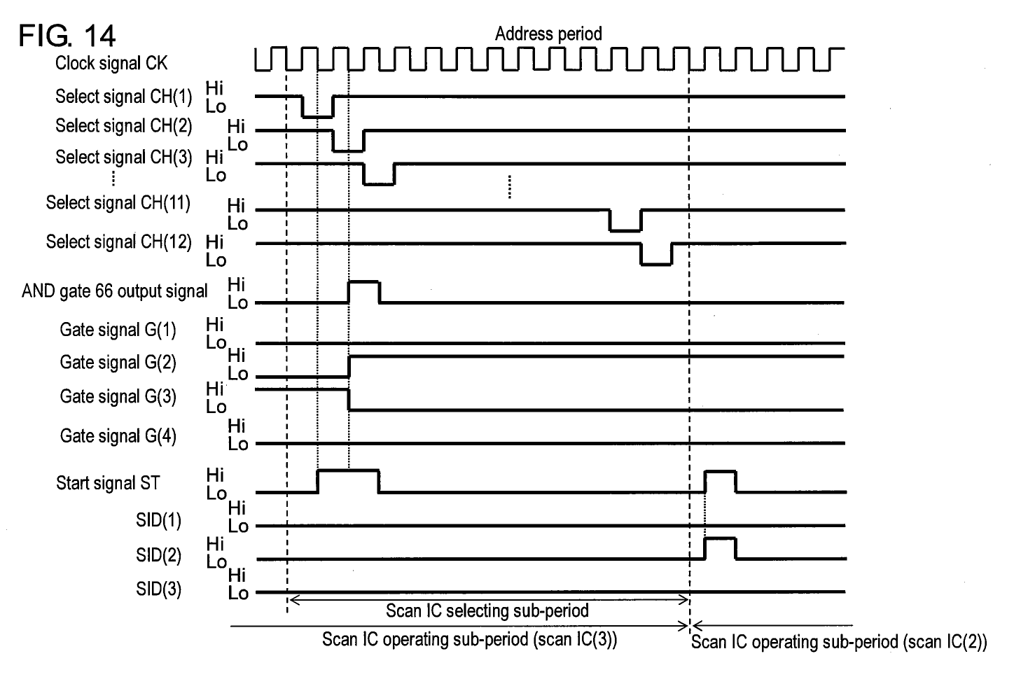

FIG. 13 is a circuit diagram showing an example of another configuration of the scan IC switching circuits in accordance with the first exemplary embodiment of the present invention. FIG. 14 is a timing chart for explaining another example of the scan IC switching operation in accordance with the first exemplary embodiment.

For example, as shown in FIG. 13, the circuit may be configured so that start signal ST is delayed in FF 65 by one cycle of clock signal CK1, and AND gate 66 performs an AND operation on start signal ST and start signal ST delayed in FF 65 by one cycle of clock signal CK1. At this time, it is preferable that clock signal CK that has a reverse polarity of clock signal CK made by logical inverter INV is input to clock input terminal CKIN of FF 65. With this configuration, when, as start signal ST, a positive pulse that is in the Hi state in the period equal to two cycles of clock signal CK2 is generated, a positive pulse in the Hi state in the period equal to one cycle of clock signal CK1 is output from AND gate 66. However, when, as start signal ST, a positive pulse that is in the Hi state in the period equal to one cycle of clock signal CK1 is generated, AND gate 66 only outputs the Lo state.

Thus, as shown in FIG. 14, instead of switch signal SR, a positive pulse that is in the Hi state only in the period equal to two cycles of clock signal CK2 is generated, as start signal ST. Then, a positive pulse output from AND gate 66 can be used as an alternative signal of switch signal SR. That is, in this configuration, start signal ST can serve as switch signal SR as well as original start signal ST. Thus the operation similar to the above can be performed without switch signal SR.

As described above, in the structure of this exemplary embodiment, the display area of panel 10 is divided into a plurality of regions, partial light-emitting rate detecting circuit 47 detects a partial light-emitting rate in each region, and the address operation is performed earlier on the regions having the higher partial light-emitting rates. This structure can prevent an increase in the scan pulse voltage (amplitude) necessary for generating a stable address discharge, and generate a stable address discharge.

In this exemplary embodiment, descriptions are provided for a structure in which each region is set according to scan electrodes 22 connected to one scan IC. However, the present invention is not limited to this structure, and each region may be set according to the other dividing methods. For example, in a structure in which the order of scanning of scan electrodes 22 can be optionally changed for each of the scan electrodes, a partial light-emitting rate can be detected for each scan electrode 22 as one region, and the order of address operations of scan electrodes 22 may be changed according to the detection results.

In this exemplary embodiment, descriptions are provided for a structure in which a partial light-emitting rate is detected in each region and the address operation is performed earlier on the regions having the higher partial light-emitting rates. However, the present invention is not limited to this structure. For example, the following structure can be used. The light-emitting rate in one display electrode pair 24 is detected as a line light-emitting rate for each display electrode pair 24, the highest line light-emitting rate is detected as a peak light-emitting rate for each region, and the address operation is performed earlier on the regions having the higher peak light-emitting rates.

The polarity of each signal shown in the explanation of the operation of scan IC switching circuit 60 is merely an example. The signal may have the polarity reverse to the polarity shown in the explanation.

### Second Exemplary Embodiment

In this exemplary embodiment, in one of subfields where a rate of luminance weight in one field is equal to or larger than a predetermined rate, or the number of sustain pulses generated in the sustain period is equal to or larger than a predetermined number, the scan ICs are sequentially switched according to the detection results in the partial light-emitting rate detecting circuit. Thus addressing is performed earlier on the regions having the higher partial light-emitting rates in decreasing order of value, as described in the first exemplary embodiment. Further, in one of subfields where a rate of luminance weight in one field is smaller than the predetermined rate, or the number of sustain pulses generated in the sustain period is smaller than the predetermined number, addressing is performed by application of scan pulse voltage Va to scan electrode SC1 through scan electrode SCn in a predetermined order. For example, scan ICs are operated so as to sequentially apply scan pulse voltage Va to scan electrode SC1 through scan electrode SCn. Such operation further stabilizes the address discharge and further improves the image display quality.

In a subfield that has a rate of luminance weight in one field is smaller than the predetermined rate, or the number of sustain pulses generated in the sustain period is smaller than the predetermined number, addressing is performed by application of scan pulse voltage Va to scan electrode SC1 through scan electrode SCn in the predetermined order. The reason for this operation is described.

The emission luminance in each subfield is expressed by the following equation:

(Emission luminance in a subfield)=(emission luminance caused by sustain discharge generated in the sustain period of the subfield)+(emission luminance caused by address discharge generated in the address period of the subfield)

However, in a subfield that has a rate of luminance weight in one field is large, or the number of sustain pulses generated in the sustain period is large (hereinafter, “high subfield”), the emission luminance caused by the sustain discharge is extremely larger than the emission luminance caused by the address discharge. Thus the emission luminance can be substantially expressed by the following equation:

(Emission luminance of a subfield)=(emission luminance caused by sustain discharge generated in the sustain period of the subfield)

In contrast, in a subfield that has a rate of luminance weight in one field is small, or the number of sustain pulses generated in the sustain period is small (hereinafter, “low subfield”), the emission luminance caused by the sustain discharge is small, and thus the emission luminance caused by the address discharge is relatively large. Thus, for example, when the discharge intensity of an address discharge and thus the emission luminance caused by the address discharge are changed, the emission luminance in the subfield can be changed by the influence.

The discharge intensity of the address discharge changes according to the order of addressing in some cases. This is due to a decrease in the wall charge with a lapse of time from the initializing operation. In a discharge cell undergoing addressing earlier, the discharge intensity of the address discharge is relatively strong and the emission luminance caused by the address discharge is relatively high. In a discharge cell undergoing addressing later, the discharge intensity of the address discharge is weaker and the emission luminance caused by the address discharge is lower than those in a cell undergoing addressing earlier.

Therefore, it is considered that, for low subfields, a discharge cell undergoing addressing later has lower emission luminance in the subfields. This change in the emission luminance is small and is unlikely to be perceived. However, in some distribution patterns of lit cells, the change is likely to be perceived.

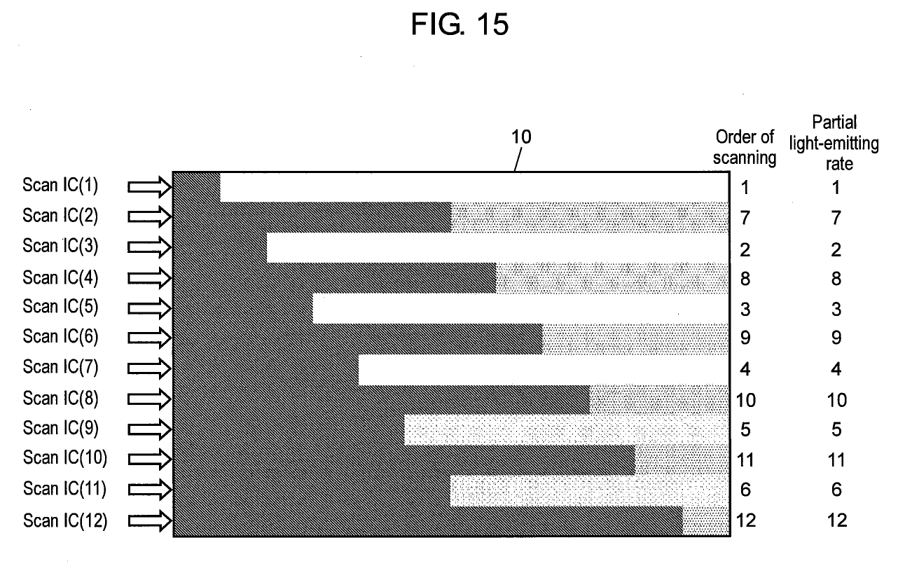

FIG. 15 is a diagram schematically showing a light-emitting state in a low subfield (e.g. the 1st SF) when a predetermined image is displayed by address operations in an order based on the partial light-emitting rates. In FIG. 15, the black portion (hatched regions) show unlit cells, and the white portion (not hatched regions) show lit cells.

For this display image, the region having the highest partial light-emitting rate is region (1) (the region connected to scan IC (1)), and the region having the second highest partial light-emitting rate is region (3) (the region connected to scan IC (3)). The partial light-emitting rates decrease in the following order: region (5), region (7), region (9), region (11), region (2), region (4), region (6), region (8), region (10), and region (12).

When this image pattern is scanned according to the partial light-emitting rates, addressing is performed on the regions in the following order: region (1), region (3), region (5), region (7), region (9), region (11), region (2), region (4), region (6), region (8), region (10), and region (12). Thus, the region undergoing addressing later is interposed between the regions undergoing addressing earlier. For example, between region (1) undergoing addressing first and region (3) undergoing addressing second, region (2) undergoing addressing seventh is interposed. Between region (3) undergoing addressing second and region (5) undergoing addressing third, region (4) undergoing addressing eighth is interposed.

As described above, the emission luminance in low subfields gradually decreases according to the order of addressing. However, the change in the emission luminance is small and is unlikely to be perceived. However, as shown in FIG. 15, when the region undergoing addressing later is interposed between the regions undergoing addressing earlier, an area in which emission luminance discontinuously changes is generated. When the change in the emission luminance is small but is generated discontinuously, the luminance change is likely to be perceived. The luminance change can be recognized as a band-shaped noise.

Thus, in this exemplary embodiment, in a subfield in which a change in the emission luminance caused by the address discharge is likely to be perceived and the emission luminance caused by the sustain discharge is small, the address operation is performed in the predetermined order.

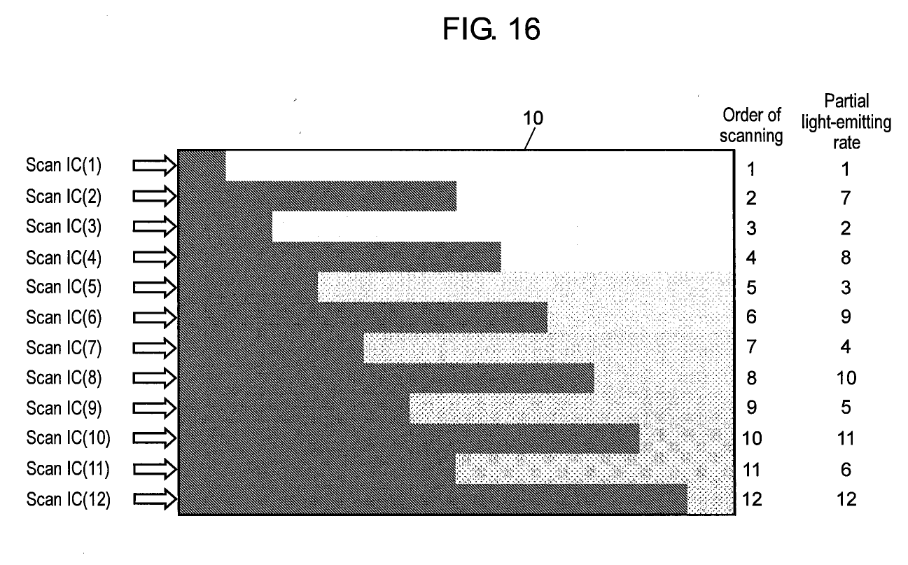

FIG. 16 is a diagram schematically showing a light-emitting state in a low subfield (e.g. the 1st SF) when an image similar to the display image of FIG. 15 is displayed by a sequential address operation from scan electrode 22 (scan electrode SC1) at the top end of panel 10 toward scan electrode 22 (scan electrode SCn) at the bottom end of panel 10.

For example, as shown in FIG. 16, when the sequential address operation is performed from scan electrode 22 (scan electrode SC1) at the top end of panel 10 toward scan electrode 22 (scan electrode SCn) at the bottom end of panel 10, the emission luminance of lit cells gradually decreases from the top end of panel 10 toward the bottom end of panel 10. Thus discontinuous luminance change is not generated on the image display surface of panel 10, and the luminance change can be smoothed. Because the luminance change based on the address discharge is small, the address operation in the order such that the luminance change is smoothed can make the luminance change unlikely to be perceived.

In this manner, in this exemplary embodiment, in a subfield in which a change in the emission luminance caused by the address discharge is likely to be perceived and the emission luminance caused by the sustain discharge is small, the address operation is performed in the predetermined order. This structure can smooth the luminance change based on the address discharge on the image display surface of panel 10 and further improve the image display quality.

In this exemplary embodiment, the above predetermined rate can be set to 1%, for example. In this case, for example, one field is formed of eight subfields (the 1st SF, and the 2nd SF through 8th SF), and the luminance weights of the respective subfields are set to 1, 2, 4, 8, 16, 32, 64, and 128. In this structure, the address operation is performed in the predetermined order in the 1st SF and the 2nd SF, i.e. SFs that have rates of luminance weight in one field is smaller than 1%. Further, the address operation is performed earlier on the regions having the higher partial light-emitting rates detected in partial light-emitting rate detecting circuit 47 in the 3rd SF through the 8th SF, i.e. SFs that have rates of luminance weight in one field is equal to or larger than 1%.

In this exemplary embodiment, the above predetermined number can be set to 6, for example. In this case, for example, one field is formed of 8 subfields (the 1st SF, and the 2nd SF through 8th SF), the luminance weights of the respective subfields are set to 1, 2, 4, 8, 16, 32, 64, and 128, and the luminance magnification is set to 4. In this structure, the numbers of sustain pulses to be generated in the sustain periods of the subfields can be obtained by quadrupling the luminance weights. Thus, in the 1st SF, i.e. a subfield that has the number of sustain pulses generated is smaller than 6, the address operation is performed in the predetermined order. Further, in the 2nd SF through the 8th SF, i.e. subfields that has the number of sustain pulses generated is 6 or larger, the address operation is performed earlier on the regions having the higher partial light-emitting rates detected in partial light-emitting rate detecting circuit 47.

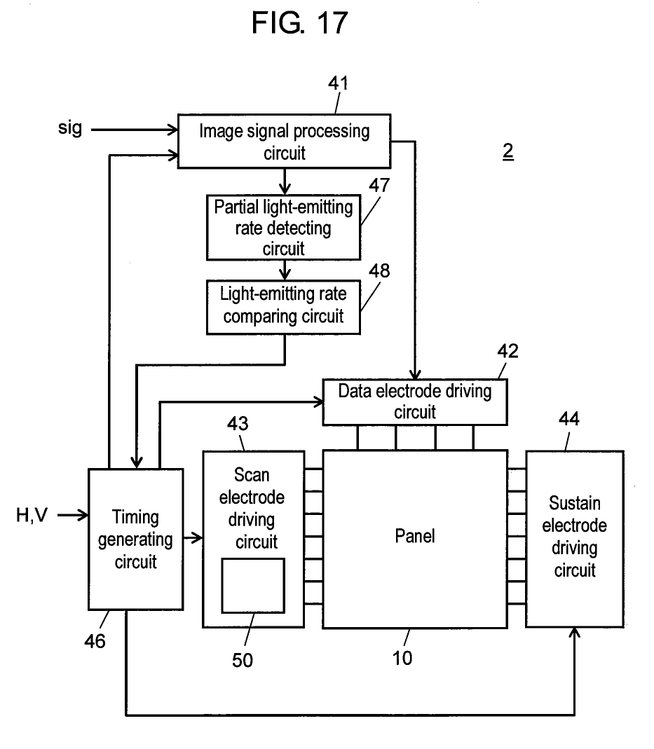

FIG. 17 is a circuit block diagram of a plasma display device in accordance with the second exemplary embodiment of the present invention.

Plasma display device 2 has the following elements:

panel 10;

image signal processing circuit 41;

data electrode driving circuit 42;

scan electrode driving circuit 43;

sustain electrode driving circuit 44;

timing generating circuit 46;

partial light-emitting rate detecting circuit 47;

light-emitting rate comparing circuit 48; and

power supply circuits (not shown) for providing power supply necessary for the respective circuit blocks. The blocks configured and operating in a similar manner to those of plasma display device 1 of the first exemplary embodiment have the same reference marks, and the descriptions thereof are omitted.

Timing generating circuit 46 generates various timing signals for controlling the operation of the respective circuit blocks according to horizontal synchronizing signal H, vertical synchronizing signal V, and the output from light-emitting rate comparing circuit 48, and supplies the timing signals to the respective circuit blocks. Timing generating circuit 46 in this exemplary embodiment determines whether the present subfield is a subfield that has a rate of luminance weight in one field is equal to or larger than a predetermined rate (e.g. 1%), or the number of sustain pulses generated in the sustain period is equal to or larger than a predetermined number (e.g. 6). Then, in a subfield that has a rate of luminance weight in one field is equal to or larger than the predetermined rate, or the number of sustain pulses generated in the sustain period is equal to or larger than the predetermined number, the respective timing signals are generated so that addressing is performed earlier on the regions having the higher partial light-emitting rates, according to the detection results in the partial light-emitting rate detecting circuit as described in the first embodiment. Further, in a subfield that has a rate of luminance weight in one field is smaller than the predetermined rate, or the number of sustain pulses generated in the sustain period is smaller than the predetermined number, the respective timing signals are generated so that scan pulse voltage Va is sequentially applied to scan electrode SC1 through scan electrode SCn in the predetermined order.

As described above, in this exemplary embodiment, the address operation is switched between the following two cases. The address operation is performed earlier on the regions having the higher partial light-emitting rates as described in the first embodiment, in a subfield that has a rate of luminance weight in one field is equal to or larger than a predetermined rate, or the number of sustain pulses generated in the sustain period is equal to or larger than a predetermined number. In contrast, the address operation is performed in the predetermined order, in a subfield in which a change in the emission luminance caused by the address discharge is likely to be perceived and emission luminance caused by the sustain discharge is small, i.e. in a subfield that has a rate of luminance weight in one field is smaller than the predetermined rate, or the number of sustain pulses generated in the sustain period is smaller than the predetermined number. This structure can smooth the luminance change based on the address discharge on the image display surface of panel 10 and further enhance the image display quality.

In this exemplary embodiment, as an example of the structure of scanning electrodes 22 in the predetermined order in a low subfield, a description is provided for a structure of the sequential address operation from scan electrode 22 (scan electrode SC1) at the top end of panel 10 toward scan electrode 22 (scan electrode SCn) at the bottom end of panel 10. However, the present invention is not limited to this structure. For example, the address operation is performed sequentially from scan electrode 22 (scan electrode SCn) at the bottom end of panel 10 toward scan electrode 22 (scan electrode SC1) at the top end of panel 10. Alternatively, the display area is divided into two regions, and the address operation is performed from scan electrodes 22 (scan electrode SC1, and scan electrode SCn) at the top end of panel 10 and at the bottom end of panel 10, respectively, toward scan electrode 22 (scan electrode SCn/2) in the center of panel 10. “Address operation in a predetermined order” in the present invention can be an address operation in any order as long as the address operation can smooth the luminance change based on the address discharge on the image display surface of panel 10.

In this exemplary embodiment, descriptions have been provided for the following structure. The address operation is switched between the two cases: a “subfield that has a rate of luminance weight in one field is equal to or larger than a predetermined rate”, or a “subfield that has the number of sustain pulses generated in the sustain period is equal to or larger than a predetermined number”; and a “subfield that has a rate of luminance weight in one field is smaller than the predetermined rate”, or a “subfield that has the number of sustain pulses generated in the sustain period is smaller than the predetermined number”. However, in an image display mode, the address operation may be switched between a “subfield that has a rate of luminance weight in one field is equal to or larger than the predetermined rate” and a “subfield that has a rate of luminance weight in one field is smaller than the predetermined rate”. In another image display mode, the address operation may be switched between a “subfield that has the number of sustain pulses generated in the sustain period is equal to or larger than the predetermined number” and a “subfield that has the number of sustain pulses generated in the sustain period is smaller than the predetermined number”. Alternatively, instead of the image display modes, such switching may be performed according to the value of the luminance magnification. In this case, in a plasma display device structured to change the value of the luminance magnification according to the average luminance level of the display image, such switching can be adaptively performed according to the average luminance level of the display image.

### Third Exemplary Embodiment

The present invention can be applied to a method for driving a panel by two-phase driving, and advantages similar to those described above can be offered. In the two-phase driving, scan electrode SC1 through scan electrode SCn are divided into a first scan electrode group and a second scan electrode group. The address period is formed of a first address period and a second address period. In the first address period, a scan pulse is applied to each of electrodes 22 belonging to the first scan electrode group. In the second address period, the scan pulse is applied to each of electrodes 22 belonging to the second scan electrode group. A second initializing operation is performed between the first address period and the second address period.

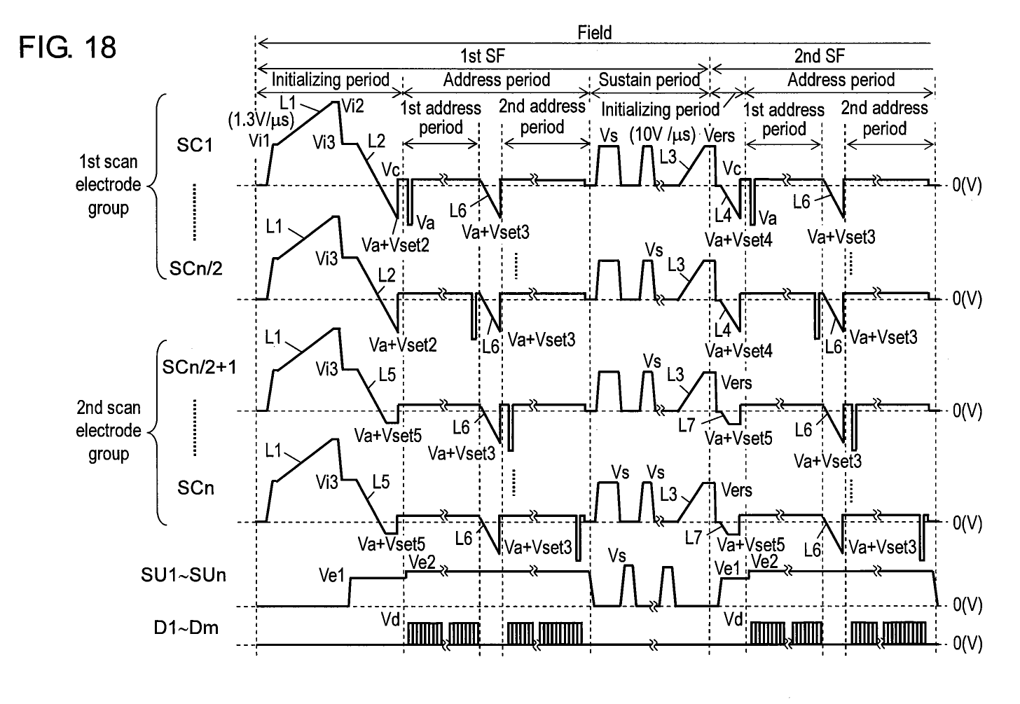

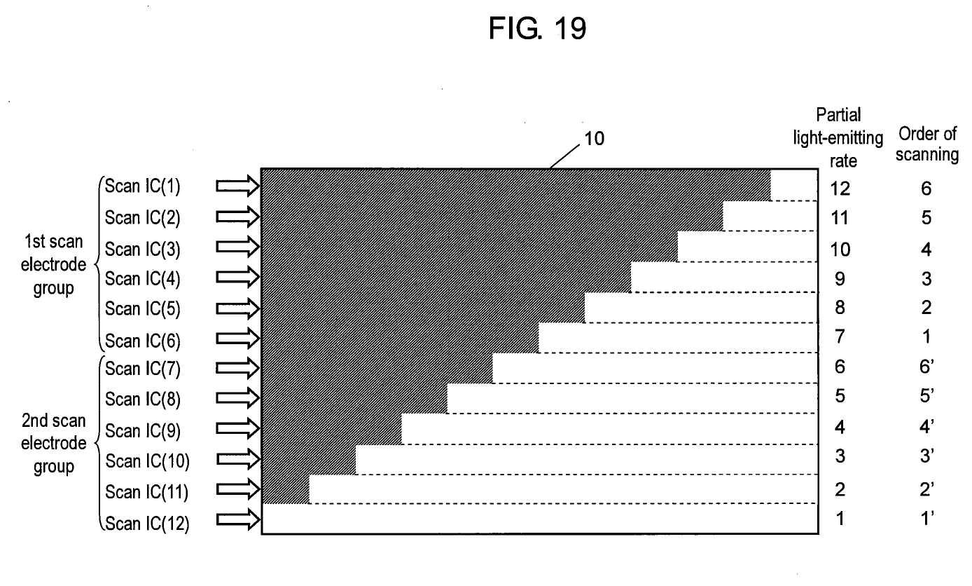

FIG. 18 is a waveform chart of driving voltages applied to the respective electrodes of panel 10 in accordance with the third exemplary embodiment of the present invention. FIG. 19 is a schematic diagram showing an example of order of scanning (an example of order of an address operation of scan IC) based on partial light-emitting rates when a predetermined image is displayed by two-phase driving in accordance with the third exemplary embodiment of the present invention. In FIG. 19, the diagonally shaded regions show the distribution of unlit cells. The outline regions that are not diagonally shaded show the distribution of lit cells. For easy understanding of each region, the boundaries between the regions are shown by broken lines.

In this exemplary embodiment, as shown in FIG. 19, scan electrodes 22 belonging to region (1) connected to scan IC (1) (hereinafter, the region connected to scan IC (n) being referred to as “region (n)”) through region (6) are set as the first scan electrode group. Scan electrodes 22 belonging to region (7) through region (12) are set as the second scan electrode group. After a first initializing operation in the initializing period is performed, an address operation is performed on the first scan electrode group (the first address period). After the address operation on the first scan electrode group is completed, a second initializing operation is performed. After the second initializing operation is completed, an address operation is performed on the second scan electrode group (the second address period).

FIG. 18 shows scan electrode SC1, scan electrode SCn/2 (e.g. scan electrode SC540), SCn/2+1 (e.g. scan electrode SC541), and scan electrode SCn (e.g. scan electrode SC1080). This chart shows an example. In this example, at the beginning of the first address period, an address operation is performed on scan electrode SC1. At the end of the first address period, an address operation is performed on scan electrode SCn/2. At the beginning of the second address period, an address operation is performed on scan electrode SCn/2+1. At the end of the second address period, an address operation is performed on scan electrode SCn. This chart also shows driving voltage waveforms of sustain electrode SU1 through sustain electrode SUn, and data electrode D1 through data electrode Dm.

First, with reference to FIG. 18, an example of the driving voltage waveforms in the two-phase driving operation is described.

The operation in the first half of the initializing period of the 1st SF is similar to the operation in the first half of the initializing period of the 1st SF in the driving voltage waveforms of FIG. 3, and thus the descriptions of the operation are omitted.

In the second half of the initializing period, positive voltage Ve1 is applied to sustain electrode SU1 through sustain electrode SUn, and 0 (V) is applied to data electrode D1 through data electrode Dm.

At this time, initializing waveforms having different waveform shapes are applied to the discharge cells undergoing only the first initializing operation and the discharge cells undergoing also the second initializing operation. Specifically, down-ramp voltages having different lowest voltages are applied.

Down-ramp voltage L2 similar to that in the second half of the initializing period of the 1st SF shown in FIG. 3 is applied to the first scan electrode group. This application causes an initializing discharge between scan electrode SC1 through scan electrode SCn/2 and sustain electrode SU1 through sustain electrode SUn/2, and between scan electrode SC1 through SCn/2 and data electrode D1 through data electrode Dm. The initializing discharge reduces the negative wall voltage on scan electrode SC1 through scan electrode SCn/2 and the positive wall voltage on sustain electrode SU1 through sustain electrode SUn/2, and adjusts the positive wall voltage on data electrode D1 through data electrode Dm to a value appropriate for the address operation.

Down-ramp voltage L5 gently decreasing from voltage V13 to negative voltage (Va+Vset5) is applied to the second scan electrode group. At this time, voltage Vset5 is set at a voltage (e.g. 70 (V)) higher than voltage Vset2 (e.g. 6 (V)).

In this manner, in the initializing period in this embodiment, down-ramp voltage L2 is decreased to voltage (Va+Vset2), but down-ramp voltage L5 is decreased only to voltage (Va+Vset5), which is higher than voltage (Va+Vset2). Thus the amount of charge that is transferred by the initializing discharge in the discharge cells applied with down-ramp voltage L5 is smaller than that in the discharge cells in which the initializing discharge is caused by down-ramp voltage L2. Therefore, in the discharge cells applied with down-ramp voltage L5, wall charge larger than that in the discharge cells applied with down-ramp voltage L2 remains.

In the subsequent address period, address operations are performed separately in the first address period in which the first scan electrode group undergoes an address operation, and in the second address period in which the second scan electrode group undergoes an address operation. However, the address operation itself is the same as the address operation shown in the address period of FIG. 3. That is, scan pulse voltage Va is applied to scan electrodes 22, positive address pulse Vd is applied to data electrode Dk (k=1 through m) corresponding to the discharge cell to be lit among data electrodes 32, and thus an address discharge is selectively caused in corresponding discharge cells.

In this exemplary embodiment, the address operation is performed on the first scan electrode group (scan electrode SC1 through scan electrode SCn/2 in FIG. 18) in the first address period, and subsequently in the second address period. After the completion of the address operation in the first address period and before the start of the address operation in the second address period, a down-ramp voltage having a lowest voltage lower than that of down-ramp voltage L5, specifically down-ramp voltage L6 decreasing from voltage Vc toward negative voltage (Va+Vset3), is applied to the second scan electrode group (scan electrodes SCn/2+1 through scan electrode SCn in FIG. 18).

As described above, down-ramp voltage L5 is decreased only to negative voltage (Va+Vset5). Thus, in the discharge cells applied with down-ramp voltage L5, a wall charge larger than that in the discharge cells applied with down-ramp voltage L2 remains. Then, voltage Vset3 (e.g. 8 (V)) is set to a voltage sufficiently lower than voltage Vset5 (e.g. 70 (V)), and down-ramp voltage L6 is decreased to a potential sufficiently lower than down-ramp voltage L5. Thereby, the second initializing discharge can be generated in the discharge cells applied with down-ramp voltage L5.

FIG. 18 shows waveforms in which down-ramp voltage L6 is also applied to the first scan electrode group at the same timing as application of down-ramp voltage L6 to the second scan electrode group. Because the address operation on the first scan electrode group is completed, down-ramp voltage L6 does not need to be applied thereto. However, when it is difficult to configure the scan electrode driving circuit so that down-ramp voltage L6 can be selectively applied, down-ramp voltage L6 may be applied to the first scan electrode group as shown in FIG. 18. This is due to the following reason. In the discharge cells in which the initializing discharge is generated by application of down-ramp voltage L2, no initializing discharge is generated again even by application of down-ramp voltage L6 that decreases only to voltage (Va+Vset3), which is higher than lowest voltage (Va+Vset2) of down-ramp voltage L2.

After the second initializing operation has been caused by down-ramp voltage L6, an address operation is performed on the second scan electrode group on which the address operation is not yet performed, according to a procedure similar to the above. After the completion of all the above address operations, the address periods of the 1st SF are completed.

During the period when down-ramp voltage L6 is applied to scan electrodes 22, no address pulse is applied to data electrode D1 through data electrode Dm.

The operation in the subsequent sustain period is similar to the operation in the sustain period of the driving voltage waveforms shown in FIG. 3, and thus the descriptions of the operation are omitted.

In the initializing period of the 2nd SF, similar to the initializing waveforms shown in the initializing period of the 2nd SF of FIG. 3, down-ramp voltage L4 decreasing from a voltage (e.g. 0 (V)) equal to or lower than the breakdown voltage toward negative voltage (Va+Vset4) is applied to the first electrode group. Down-ramp voltage L7 that decreases from a voltage (e.g. 0 (V)) equal to or lower than the breakdown voltage toward negative voltage (Va+Vset5) is applied to the second scan electrode group.

The operations in the address periods and the sustain period of the 2nd SF are similar to the operations in the address periods and the sustain period of the 1st SF, and thus the descriptions are omitted. In the 3rd SF and thereafter, the driving voltage waveforms similar to those in the 2nd SF are applied to scan electrode SC1 through scan electrode SCn, sustain electrode SU1 through sustain electrode SUn, and data electrode D1 through data electrode Dm, except that the numbers of sustain pulses in the sustain periods are different.

The driving voltage waveforms applied to the respective electrodes of panel 10 in two-phase driving have been outlined as above. In this exemplary embodiment, the following address operations are performed when a panel is driven by this two-phase driving.

In the display image shown in FIG. 19, the region having the highest partial light-emitting rate is region (12) connected to scan IC (12). The partial light-emitting rates in the other regions decrease in the following order: region (11), region (10), region (9), region (8), region (7), region (6), region (5), region (4), region (3), region (2), and region (1). Scan electrodes 22 belonging to region (1) through region (6) are set as the first scan electrode group. Scan electrodes 22 belonging to region (7) through region (12) are set as the second scan electrode group.

In this example, after the first initializing operation performed in the initializing period, an address operation is performed on the six regions, i.e. region (1) through region (6). The address operation is performed earlier on the regions having the higher partial light-emitting rates, as shown in the following order of scanning of 1 through 6 in FIG. 19: region (6), region (5), region (4), region (3), region (2), and region (1). After the second initializing operation, an address operation is performed on the remaining six regions, i.e. region (7) through region (12). The address operation is performed earlier on the regions having the higher partial light-emitting rates, as shown in the following order of scanning of 1′ through 6′ in FIG. 19: region (12), region (11), region (10), region (9), region (8), and region (7).

In this manner, even when panel 10 is driven by two-phase driving, as shown in the first exemplary embodiment, the address operation is performed earlier on the regions having the higher partial light-emitting rates in decreasing order of value. This operation can prevent an increase in the scan pulse voltage (amplitude) necessary for generating a stable address discharge, and generate a stable address discharge. Further, in the two-phase driving operation, the second initializing operation is performed in the middle of the address period. Thus the time from the initializing operation to the address operation is reduced, and a further stable address operation can be performed.

The exemplary embodiments of the present invention are also effective in a panel having an electrode array in which scan electrode 22 is adjacent to scan electrode 22 and sustain electrode 23 is adjacent to sustain electrode 23. In the electrode array, the electrodes are arranged on front plate 21 in the following order: a scan electrode, a scan electrode, a sustain electrode, a sustain electrode, a scan electrode, a scan electrode, or the like.

In the exemplary embodiments of the present invention, descriptions have been provided for a structure in which erasing ramp voltage L3 is applied to scan electrode SC1 through scan electrode SCn. However, erasing ramp voltage L3 may be applied to sustain electrode SU1 through sustain electrode SUn. Alternatively, instead of erasing ramp voltage L3, so-called a narrow-width erasing pulse may be used to generate an erasing discharge.

The specific numerical values in the exemplary embodiments of the present invention are based on the characteristics of a 50-inch diagonal panel having 1,080 display electrode pairs 24, and merely show examples in the exemplary embodiments. The present invention is not limited to these numerical values. Preferably, numerical values are set optimum for the characteristics of panel 10, the specifications of plasma display device 1, or the like. For each of these numerical values, variations are allowed within the range in which the above advantages can be offered. Further, the numbers of the subfields, luminance weights of the respective subfields, or the like are not limited to the values shown in the exemplary embodiments of the present invention. The subfield structure may be switched according to image signals, or the like.

### INDUSTRIAL APPLICABILITY

The present invention can prevent an increase in the scan pulse voltage (amplitude) necessary for generating a stable address discharge, and generate a stable address discharge. Thereby, a high quality of image display can be achieved, even in a panel of a large screen size and high definition. Thus the present invention is useful as a plasma display device and a driving method for a panel.

1. A plasma display device comprising:
a plasma display panel,
the plasma display panel being driven by a subfield method in which a plurality of subfields are set in one field,
the subfield having an initializing period, an address period, and a sustain period,
a luminance weight being set for each of the subfields, and sustain pulses corresponding to the number of the luminance weight being generated in the sustain period so that gradation display is provided,
the plasma display panel having a plurality of discharge cells, each of the discharge cells having a display electrode pair, the display electrode pair including a scan electrode and a sustain electrode;
a scan electrode driving circuit for performing an address operation by sequentially applying a scan pulse to the scan electrodes, in the address period; and
a partial light-emitting rate detecting circuit for dividing a display area of the plasma display panel into a plurality of regions, and for detecting a rate of the number of the discharge cells to be lit with respect to the number of the discharge cells, as a partial light-emitting rate for each of the regions and for each of the subfields in each of the regions,
wherein the scan electrode driving circuit performs the address operation earlier on the regions having the higher light-emitting rates detected in the partial light-emitting rate detecting circuit.

2. The plasma display device of claim 1, wherein
the partial light-emitting rate detecting circuit detects a light-emitting rate for each of the display electrode pairs, and detects a maximum value of the light-emitting rates in the regions, as a maximum light-emitting rate for each of the regions; and
the scan electrode driving circuit performs the address operation earlier on the regions having the higher maximum light-emitting rates.

3. The plasma display device of claim 1, wherein
the scan electrode driving circuit has a plurality of scan integrated circuits (ICs) capable of performing the address operation on the plurality of scan electrodes; and
the partial light-emitting rate detecting circuit sets an area that is formed of the plurality of scan electrodes connected to one of the scan ICs, as one of the regions.

4. The plasma display device of claim 1, wherein
in one of the subfields where a rate of the luminance weight in the one field is equal to or larger than a predetermined rate or the number of the sustain pulses generated in the sustain period is equal to or larger than a predetermined number, the scan electrode driving circuit performs the address operation earlier on the regions having the higher partial light-emitting rates detected in the partial light-emitting rate detecting circuit; and
in one of the subfields where a rate of the luminance weight in the one field is smaller than the predetermined rate or the number of the sustain pulses generated in the sustain period is smaller than the predetermined number, the scan electrode driving circuit performs the address operation in a predetermined order.

5. The plasma display device of claim 4, wherein the predetermined rate is 1%.

6. The plasma display device of claim 4, wherein the predetermined number is 6.

7. A driving method for a plasma display panel,
the plasma display panel having a plurality of discharge cells, each of the discharge cells having a display electrode pair, the display electrode pair including a scan electrode and a sustain electrode,
the plasma display panel being driven by a subfield method in which a plurality of subfields are set in one field,
the subfield having an initializing period, an address period, and a sustain period,
a luminance weight being set for each of the subfields, a scan pulse is sequentially applied to the scan electrodes for an address operation in the address period, and sustain pulses corresponding to the number of the luminance weight are generated in the sustain period so that gradation display is provided,
the driving method comprising:
dividing a display area of the plasma display panel into a plurality of regions, and detecting a rate of the number of the discharge cells to be lit with respect to the number of the discharge cells, as a partial light-emitting rate for each of the regions and for each of the subfields in each of the regions; and
performing the address operation earlier on the regions having the higher light-emitting rates detected.
